(19) United States
(12) Patent Application Publication
(10) Pub. No.: US 2017/0078640 A1
(43) Pub. Date: Mar. 16, 2017

(54) IMAGING APPARATUS, IMAGE PROCESSING METHOD, AND PROGRAM

(71) Applicant: Sony Corporation, Tokyo (JP)

(72) Inventor: Eiji Otani, Kanagawa (JP)

(73) Assignee: Sony Corporation

(21) Appl. No.: 15/361,264

(22) Filed: Nov. 25, 2016

Related U.S. Application Data
(63) Continuation of application No. 13/359,085, filed on Jan. 26, 2012.

(30) Foreign Application Priority Data
Feb. 17, 2011 (JP) 2011-031486

(51) Int. Cl. H04N 13/00; G03B 35/10; H04N 13/02

(52) U.S. Cl. CPC H04N 13/0018; H04N 13/0225; H04N 13/0257; G03B 35/10

(57) ABSTRACT

An imaging apparatus includes first and second polarizers that polarize light from a subject in perpendicular polarization directions. Third and fourth polarizers are alternately disposed in a photodetection plane of an imaging device along a second direction perpendicular to a first direction, along which the first polarizer and the second polarizer are connected to each other, in such a way that the third and fourth polarizers extend in the second direction, and have polarization directions that are parallel to that of the first and second polarizers. An image processor processes image data produced by the imaging device such that image data from light passing through the first and third polarizers are handled as first image data for displaying stereoscopic images and image data from light passing through the second and fourth polarizers are handled as second image data for displaying the stereoscopic images.

### CROSS REFERENCES TO RELATED APPLICATIONS

This Application is a Continuation Application of application Ser. No. 13/359,085, filed Jan. 26, 2012, which in turn claims priority from Japanese Priority Patent Application JP 2011-031486 filed in the Japan Patent Office on Feb. 17, 2011, the entire contents of which are hereby incorporated by reference.

### FIELD

The present disclosure relates to an imaging apparatus, and particularly to an imaging apparatus that produces stereoscopic images, an image processing method, and a program that instructs a computer to carry out the method.

### BACKGROUND

There have been proposed digital still cameras, digital video camcorders (camera-recorder hybrids), and other imaging apparatus that produce image data for displaying stereoscopic images that allow a viewer to experience stereoscopic vision with the aid of parallax between the right and left eyes.

For example, there has been a proposed imaging apparatus that includes two lenses and one imaging device and produces two images (image for right vision and image for left vision) for displaying stereoscopic images (see JP-A-2004-309868, for example).

### SUMMARY

According to the technology of the related art described above, the two lenses and the one imaging device can be used to produce two images (image for right vision and image for left vision). To record the thus produced two images (image for right vision and image for left vision), it is, for example, assumed to use a predetermined recording format.

Stereoscopic images (image for right vision and image for left vision, for example) are often recorded based on a predetermined recording format as follows: Images to be recorded are thinned out or otherwise processed, and the resultant two images are handled as a single image. To record stereoscopic images based on a predetermined recording format, it is therefore important to reduce degradation in quality of the stereoscopic images due to the thinning-out or other processes.

Thus, it is desirable to reduce degradation in quality of stereoscopic images.

An embodiment of the present disclosure is directed to an imaging apparatus including two polarizers that are disposed in the vicinity of a diaphragm and polarize light from a subject, the two polarizers being a first polarizer and a second polarizer whose polarization directions are perpendicular to each other; two polarizers that polarize the light from the subject and are alternately disposed in a photodetection plane of an imaging device along a second direction perpendicular to a first direction, along which the first polarizer and the second polarizer are connected to each other, in such a way that the two polarizers extend in the second direction, the two polarizers being a third polarizer whose polarization direction is parallel to the polarization direction of the first polarizer and a fourth polarizer whose polarization direction is parallel to the polarization direction of the second polarizer; and an image processor that processes image data produced by the imaging device in such a way that image data produced based on light having passed through the first polarizer and the third polarizer are handled as first image data for displaying stereoscopic images and image data produced based on light having passed through the second polarizer and the fourth polarizer are handled as second image data for displaying the stereoscopic images. The embodiment of the present disclosure is also directed to an image processing method used with the imaging apparatus and a program that instructs a computer to carry out the method. The apparatus, the method, and the program allow image data produced based on the light having passed through the first polarizer and the third polarizer to be used as first image data for displaying stereoscopic images and image data produced based on the light having passed through the second polarizer and the fourth polarizer to be used as second image data for displaying the stereoscopic images.

In the embodiment, the imaging device may have pixels arranged in a matrix identified by the first direction and the second direction, and the third polarizer and the fourth polarizer may be alternately disposed on a predetermined arrangement unit basis, the predetermined arrangement unit being a line or lines extending in the second direction and the line corresponding to two pixels in the first direction in the imaging device. The configuration described above allows the first image data and the second image data to be produced by using image data produced by the imaging device having pixels arranged in a matrix identified by the first direction and the second direction and having the third polarizer and the fourth polarizer alternately disposed on a predetermined arrangement unit basis, the predetermined arrangement unit being a line or lines extending in the second direction and the line corresponding to two pixels in the first direction.

In the embodiment, the image processor may produce the first image data and the second image data by rearranging the image data produced by the imaging device on a predetermined unit basis, the predetermined unit being a line extending in the second direction and corresponding to each of the third polarizer and each of the fourth polarizer. The configuration described above allows the first image data and the second image data to be produced by the image data produced by the imaging device on a predetermined unit basis, the predetermined unit being a line extending in the second direction and corresponding to each of the third polarizers and each of the fourth polarizers.

In the embodiment, the image processor may produce the first image data and the second image data by summing the image data produced by the imaging device on a predetermined unit basis, the predetermined unit being a line extending in the second direction and corresponding to each of the third polarizers and each of the fourth polarizers, and then rearranging the summed image data. The configuration described above allows the first image data and the second image data to be produced by summing the image data produced by the imaging device on a predetermined unit basis, the predetermined unit being a line extending in the second direction and corresponding to each of the third polarizers and each of the fourth polarizers, and then rearranging the summed image data.

In the embodiment, the image processor may process the image data produced by the imaging device in such a way that image data sequentially read on a predetermined unit basis, the predetermined unit being a line extending in the second direction and corresponding to each of the third polarizers, are handled as the first image data, and image data sequentially read on a predetermined unit basis, the predetermined unit being a line extending in the second direction and corresponding to each of the fourth polarizers, are handled as the second image data. The configuration described above allows the image data produced by the imaging device to be processed in such a way that image data sequentially read on a predetermined unit basis, the predetermined unit being a line extending in the second direction and corresponding to each of the third polarizers, are handled as the first image data, and that image data sequentially read on a predetermined unit basis, the predetermined unit being a line extending in the second direction and corresponding to each of the fourth polarizers, are handled as the second image data.

In the embodiment, the image processor may process the image data produced by the imaging device in such a way that image data on a predetermined unit basis, the predetermined unit being a line extending in the second direction and corresponding to each of the third polarizers, are summed and the summed image data are then sequentially read and handled as the first image data, and that image data on a predetermined unit basis, the predetermined unit being a line extending in the second direction and corresponding to each of the fourth polarizers, are summed and the summed image data are then sequentially read and handled as the second image data. The configuration described above allows the image data produced by the imaging device to be processed in such a way that image data on a predetermined unit basis, the predetermined unit being a line extending in the second direction and corresponding to each of the third polarizers, are summed and the summed image data are then sequentially read and handled as the first image data, and that image data on a predetermined unit basis, the predetermined unit being a line extending in the second direction and corresponding to each of the fourth polarizers, are summed and the summed image data are then sequentially read and handled as the second image data.

In the embodiment, the pixels in the imaging device may be disposed in a primary color Bayer arrangement. The configuration described above allows the first image data and the second image data to be produced by using image data produced by the imaging device having pixels disposed in a primary color Bayer arrangement.

In the embodiment, the first polarizer and the second polarizer may be disposed adjacent to each other on opposite sides of the second direction as a boundary in the vicinity of the diaphragm in a single optical system that collects the light from the subject. The configuration described above allows the first image data and the second image data to be produced by using the first polarizer and the second polarizer disposed adjacent to each other on opposite sides of the second direction as a boundary in the vicinity of the diaphragm in a single optical system that collects the light from the subject.

In the embodiment, the first polarizer may be disposed in the vicinity of the diaphragm in a first optical system that collects the light from the subject, and the second polarizer may be disposed in the vicinity of the diaphragm in a second optical system that collects the light from the subject. The configuration described above allows the first image data and the second image data to be produced by using the first polarizer disposed in the vicinity of the diaphragm in the first optical system that collects the light from the subject and the second polarizer disposed in the vicinity of the diaphragm in the second optical system that collects the light from the subject.

In the embodiment, the image processor may produce the first image data and the second image data as image data to be recorded on a recording medium based on a predetermined recording format. The configuration described above allows the first image data and the second image data to be produced as image data to be recorded on a recording medium based on a predetermined recording format.

In the embodiment, the image processor may produce the first image data and the second image data as image data to be recorded on a recording medium based on a recording format using a side by side scheme. The configuration described above allows the first image data and the second image data to be produced as image data to be recorded on a recording medium based on a recording format using the side by side scheme.

In the embodiment, the first direction may be a direction of parallax associated with the stereoscopic images. The configuration described above allows the first image data and the second image data to be produced by setting the first direction to be a direction of parallax associated with the stereoscopic images.

The present disclosure can provide an excellent effect of reducing degradation in quality of stereoscopic images.

### BRIEF DESCRIPTION OF THE DRAWINGS

FIGS. 1A and 1B show an example of the internal configuration of an imaging apparatus in a first embodiment of the present disclosure;

FIGS. 2A and 2B diagrammatically show a pupil polarizing unit and an imaging device polarizing unit in the first embodiment of the present disclosure;

FIGS. 3A and 3B show an example of the arrangement of a third polarizer and a fourth polarizer that form the imaging device polarizing unit in the first embodiment of the present disclosure;

FIGS. 4A to 4D diagrammatically show the relationship between the stream of light through a lens system, the pupil polarizing unit, and the imaging device polarizing unit and images produced by the light in the first embodiment of the present disclosure;

FIG. 5 diagrammatically shows image processing (demosaicing) performed by an image processor in the first embodiment of the present disclosure;

FIGS. 6A and 6B diagrammatically show an imaging device and the imaging device polarizing unit in the first embodiment of the present disclosure;

FIGS. 7A and 7B schematically show a semiconductor process procedure according to which a wire-grid polarizer is formed in the first embodiment of the present disclosure;

FIGS. 8A and 8B diagrammatically show an example of an image processing method carried out when the image processor produces images to be recorded in the first embodiment of the present disclosure;

FIGS. 9A to 9C diagrammatically show the relationship between image data to be recorded having been produced by the image processor and stereoscopic images to be displayed in the first embodiment of the present disclosure;

FIG. 10 shows a variation of the arrangement of the polarizers that form the imaging device polarizing unit in the first embodiment of the present disclosure;

FIG. 11 is a flowchart showing an example of an image processing procedure performed by the imaging apparatus in the first embodiment of the present disclosure;

FIG. 12 is a flowchart showing another example of the image processing procedure performed by the imaging apparatus in the first embodiment of the present disclosure;

FIG. 13 schematically shows the interval, the height, and the width of the wire-grid polarizer in the first embodiment of the present disclosure;

FIGS. 14A to 14C show examples of calculation results obtained by changing the interval, the height, and the duty of the wire-grid polarizer in the first embodiment of the present disclosure;

FIGS. 15A to 15C show examples of calculation results obtained by changing the length of the wire-grid polarizer in the first embodiment of the present disclosure;

FIGS. 16A and 16B show a simulation of light propagation through the wire-grid polarizer in the first embodiment of the present disclosure; and

FIG. 17 is a perspective view showing an example of the internal configuration of an imaging apparatus in a second embodiment of the present disclosure.

### DETAILED DESCRIPTION

A mode for carrying out the present disclosure (hereinafter referred to as “embodiment”) will be described below. The description will be made in the following order:

1. First embodiment (image processing control: a case where an imaging apparatus including a single lens system (what is called a single-lens reflex 3D camera) produces stereoscopic images)

2. Second embodiment (image processing control: a case where an imaging apparatus including a plurality of lens systems (what is called a twin-lens 3D camera) produces stereoscopic images)

### 1. First Embodiment

### [Example of Configuration of Imaging Apparatus]

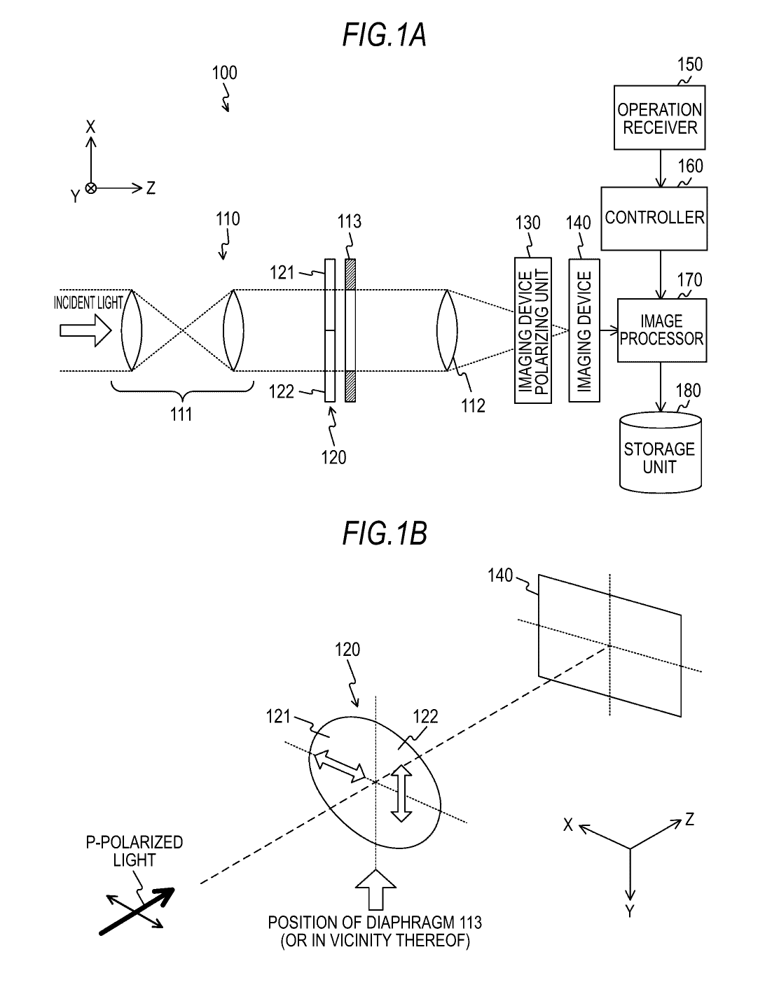

FIGS. 1A and 1B show an example of the internal configuration of an imaging apparatus 100 according to a first embodiment of the present disclosure. FIG. 1A is a schematic top view of a lens system 110, a pupil polarizing unit 120, an imaging device polarizing unit 130, and an imaging device 140 viewed from above. FIG. 1B is a schematic perspective view showing the relationship between the pupil polarizing unit 120 and the imaging device 140.

The imaging apparatus 100 includes the lens system 110, the pupil polarizing unit 120, the imaging device polarizing unit 130, the imaging device 140, an operation receiver 150, a controller 160, an image processor 170, and a storage unit 180. Directions involved in the following description are defined as follows: The horizontal axis is an X-axis direction; the vertical axis is a Y-axis direction; and the direction in which light travels is a Z-axis direction. The imaging apparatus 100 can, for example, be a digital camera, a digital video camcorder (camera-recorder hybrid, for example), or any other imaging apparatus. The imaging device 100 can, for example, be a front-surface-illuminated solid-state imaging device or a rear-surface-illuminated solid-state imaging device.

The lens system 110 includes an imaging lens 111, an image forming lens 112, and a diaphragm 113. The lens system 110 functions, for example, as a focus lens and a zoom lens.

The imaging lens 111 collects light incident from a subject. The imaging lens 111 includes a focus lens for focusing and a zoom lens for enlarging an image of the subject. The imaging lens 111 is typically formed of a combination of a plurality of lenses to correct chromatic and other aberrations.

The image forming lens 112 focuses light having passed through the pupil polarizing unit 120 and forms an image on the imaging device 140.

The diaphragm 113 has a function of limiting light to adjust the amount of collected light and is formed, for example, of a combination of a plurality of plate-shaped blades. Further, light from at least a single point on the subject is parallelized in the position of the diaphragm 113.

The lens system 110 may be formed of a single-focus lens or what is called a zoom lens. The configuration of the lens system 110 can be determined based on the specifications required for the lens system 110.

The pupil polarizing unit 120 includes a first polarizer 121 and a second polarizer 122 disposed along the vertical direction (Y-axis direction) and polarizes the light from the subject. The polarizer used herein means a component that converts natural light (non-polarized light) or circularly polarized light into linearly polarized light. Each of the first polarizer 121 and the second polarizer 122 can, for example, be a polarizer having a known configuration (polarizing plate or polarizing filter, for example).

The light incident on the lens system 110 is parallelized and then focused on the imaging device 140 (image is formed thereon), and the pupil polarizing unit 120 is preferably in a position in the lens system 110 where the light remains parallelized. Further, the pupil polarizing unit 120 is preferably disposed, for example, in a position where it does not affect the operation of the diaphragm 113 (a position closest possible to the diaphragm 113). For example, the pupil polarizing unit 120 is preferably disposed in the vicinity of the diaphragm 113 in the lens system 110. When the pupil polarizing unit 120 is disposed as described above, it is not typically necessary to redesign a new optical system of the lens system but it is only necessary to change the mechanical (physical) design of an existing lens system in such a way that the pupil polarizing unit 120 can be fixed thereto (or removably disposed therein). The pupil polarizing unit 120 can thus be disposed.

The pupil polarizing unit 120, when removably disposed in the lens system, can, for example, be configured similarly to the blades of the diaphragm in the lens system and disposed in the lens system. Alternatively, a member including the pupil polarizing unit 120 and an aperture can be so disposed in the lens system that the member pivotally moves around a pivotal axis parallel to the optical axis of the lens system. In this case, the member, when pivoted around the pivotal axis, allows light rays traveling through the lens system to pass through the aperture or the pupil polarizing unit 120. Still alternatively, the member including the pupil polarizing unit 120 and the aperture can be so disposed in the lens system that the member can slide in the direction perpendicular to the optical axis of the lens system. In this case, the member, when caused to slide, allows light rays traveling through the lens system to pass through the aperture or the pupil polarizing unit 120.

Further, for example, the pupil polarizing unit 120 has a circular outer shape, and each of the first polarizer 121 and the second polarizer 122 has a semicircular outer shape that occupies one half the pupil polarizing unit 120. In this case, the boundary between the first polarizer 121 and the second polarizer 122 extends along the vertical direction (Y-axis direction). The pupil polarizing unit 120, which is formed of the first polarizer 121 and the second polarizer 122, divides the light incident thereon into two light fluxes having different polarization states. Specifically, the pupil polarizing unit 120 is formed of polarizers symmetric with respect to the boundary (first polarizer 121 and second polarizer 122). The pupil polarizing unit 120, specifically, two portions thereof on the right and left sides defined with respect to the imaging apparatus 100 in an upright position, produces linearly polarized light fluxes having polarization directions perpendicular to each other or circularly polarized light fluxes having polarization directions oriented in opposite directions.

The first polarizer 121 is a polarizer (polarizing filter, for example) that polarizes an image of the subject intended to be viewed with the right eye (light intended to be received by the right eye). On the other hand, the second polarizer 122 is a polarizer (polarizing filter, for example) that polarizes an image of the subject intended to be viewed with the left eye (light intended to be received by the left eye). For example, a P polarizer (first polarizer 121) is disposed in a left portion of the pupil in the position of (in the vicinity of) the diaphragm 113, and an S polarizer (second polarizer 122) is disposed on a right portion of the pupil in the position of 113 (in the vicinity of) the diaphragm. The light having passed through each of the first polarizer 121 and the second polarizer 122 can thus be linearly polarized. The positions of the P polarizer and the S polarizer can be reversed. Alternatively, the light having passed through each of the first polarizer 121 and the second polarizer 122 may be circularly polarized (as long as the polarization directions of the circularly polarized light fluxes are oriented in opposite directions). In general, a transverse wave oscillating only in a specific direction is called a polarized wave, and the oscillation direction is called a polarization direction or a polarization axis. The orientation of the electric field of light coincides with the polarization direction.

As described above, the lens system 110 and the pupil polarizing unit 120 not only have zooming, focusing, light limiting, and other optical functions but also divides light into right and left images produced by light fluxes polarized perpendicular to each other (images corresponding to parallax between the right and left eyes) in the position of the diaphragm 113, which is the pupil position.

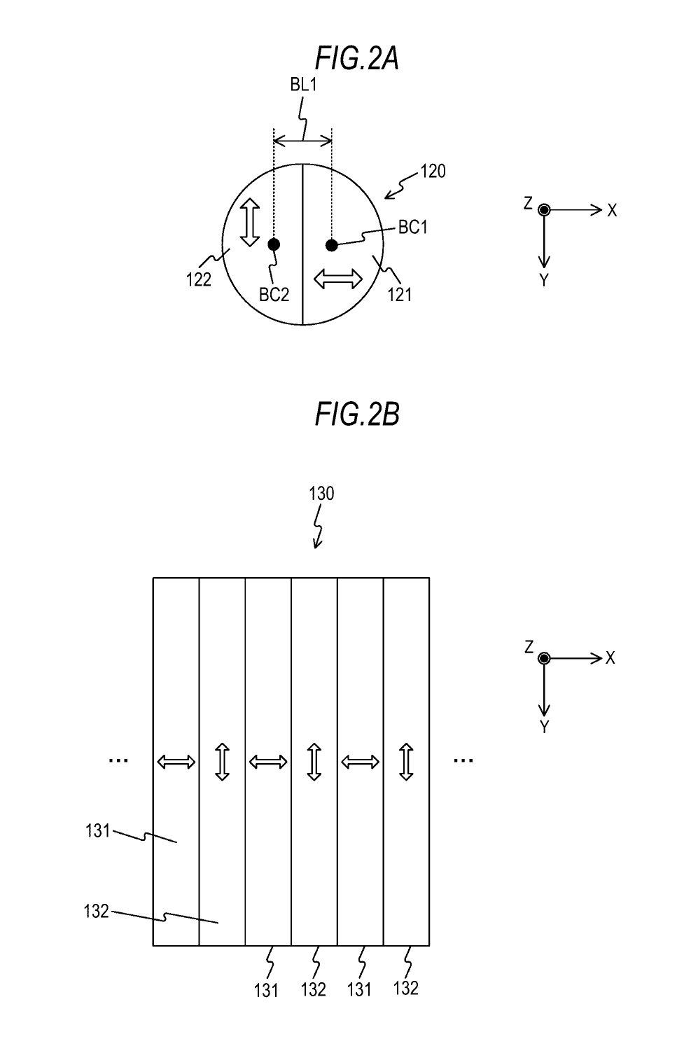

The imaging device polarizing unit 130 includes a third polarizer 131 and a fourth polarizer 132 (shown in FIG. 2B) alternately disposed along the horizontal direction (X-axis direction) and extending in the vertical direction (Y-axis direction). The relationship between the first polarizer 121/the second polarizer 122 in the pupil polarizing unit 120 and the third polarizer 131/the fourth polarizer 132 in the imaging device polarizing unit 130 will be described in detail with reference to FIGS. 2A and 2B.

The imaging device 140 has pixels arranged in a matrix extending in the horizontal and vertical directions for producing image signals and has the imaging device polarizing unit 130 disposed on the light incident side of the imaging device 140. That is, the imaging device polarizing unit 130 and the imaging device 140 form a polarization image sensor. The imaging device 140 converts the light collected by the lens system 110 into an electric signal. That is, the imaging device 140 independently but simultaneously receives the right and left light fluxes separated by the pupil polarizing unit 120 (light fluxes corresponding to image for right vision and image for left vision). Image data for right vision and image data for left vision are thus produced based on the converted electric signal from the imaging device 140. The imaging device 140 can, for example, be a CCD (charge coupled device) sensor or a CMOS (complementary metal oxide semiconductor) sensor. The imaging device 140 can alternatively be a CMD (charge modulation device) sensor or any other signal amplification image sensor. In the configuration described above, an entrance pupil is positioned between the image forming lens 112 and the imaging device 140 but closer to the latter.

The operation receiver 150 receives an input issued by a user and outputs an operation signal according to the received input to the controller 160. For example, the operation receiver 150 receives an instruction to record still images (stereoscopic images) and an instruction to start (or stop) recording video images (stereoscopic images).

The controller 160 controls the entire imaging apparatus 100. For example, the controller 160 performs control according to an input issued by the user and received by the operation receiver 150.

The image processor 170 performs a various kinds of image processing on the electric signal outputted from the imaging device 140 and stores the electric signal (image data) having undergone the various kinds of image processing in the storage unit 180. For example, the image processor 170 converts the electric signal (image data) outputted from the imaging device 140 into image data for right vision and image data for left vision (what is called 3D image processing). The image processor 170 then stores the converted image data for right vision and image data for left vision as stereoscopic image contents in the storage unit 180. The image processor 170 further outputs the converted image data for right vision and image data for left vision as stereoscopic images to a display device (not shown) and displays them thereon.

The storage unit 180 is a recording medium on which a variety of data are stored. The storage unit 180 can, for example, be a semiconductor memory, an optical disc, and a hard disk drive. The semiconductor memory can, for example, be a flash ROM (read only memory) or a DRAM (dynamic random access memory). The optical disc can, for example, be a BD (Blu-ray Disc), a DVD (digital versatile disc), and a CD (compact disc). The storage unit 180 can alternatively be a storage device built in the imaging apparatus 100 or a memory card or any other removable medium (recording medium) that can be loaded and unloaded to and from the imaging apparatus 100.

### [Example of Relationship Between Pupil Polarizing Unit and Imaging Device Polarizing Unit]

FIGS. 2A and 2B diagrammatically show the pupil polarizing unit 120 and the imaging device polarizing unit 130 in the first embodiment of the present disclosure. FIG. 2A shows the polarization directions in the pupil polarizing unit 120, and FIG. 2B shows the polarization directions in the imaging device polarizing unit 130. FIG. 2B shows only part of the third polarizers 131 and the fourth polarizers 132 in the imaging device polarizing unit 130. FIGS. 2A and 2B are diagrammatic front views of the pupil polarizing unit 120 and the imaging device polarizing unit 130, respectively, viewed from the side where the imaging device 140 is present.

The polarization directions of the first polarizer 121 and the second polarizer 122 are perpendicular to each other, as shown in FIG. 2A (indicated by open arrows). That is, the orientation of the electric field of the light having passed through the first polarizer 121 (first pass-through light) and the orientation of the electric field of the light having passed through the second polarizer 122 (second pass-through light) are perpendicular to each other.

Now, for example, suppose that the pupil polarizing unit 120 has a circular outer shape having a radius r (=10 mm). Each of the first polarizer 121 and the second polarizer 122 has a semicircular shape that occupies one half the pupil polarizing unit 120. Now, the center of gravity determined based on the outer shape of the first polarizer 121 is called a center of gravity BC1 in the area of the first polarizer 121, and the center of gravity determined based on the outer shape of the second polarizer 122 is called a center of gravity BC2 in the area of the second polarizer 122. In this case, the distance between the center of gravity BC1 and the center of gravity BC2 (base line length) can be determined as follows: “(8r)/(3π) (=8.5 mm).”

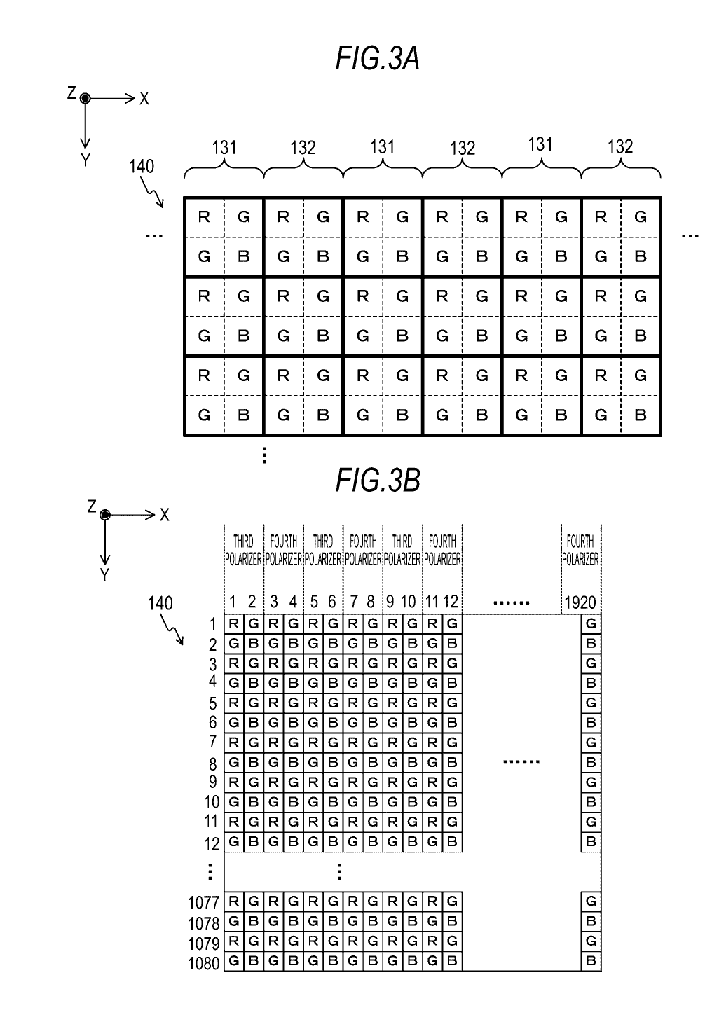

The polarization directions of the third polarizers 131 and the fourth polarizers 132 are perpendicular to each other, as shown in FIG. 2B (indicated by open arrows). That is, the orientation of the electric field of the light having passed through the third polarizers 131 (third pass-through light) and the orientation of the electric field of the light having passed through the fourth polarizers 132 (fourth pass-through light) are perpendicular to each other. The third polarizers 131 and the fourth polarizers 132 are alternately arranged on a predetermined unit basis, the predetermined unit being a line (vertical line) corresponding to two pixels in the horizontal direction in the imaging device 140. FIGS. 3A and 3B show the arrangement of the third polarizers 131 and the fourth polarizers 132.

Now, for example, consider a case where the orientation of the electric field of the first pass-through light is parallel to the horizontal direction. In this case, the first pass-through light primarily has a P-wave (TM-wave) polarization component, and the second pass-through light primarily has an S-wave (TE-wave) polarization component. The orientation of the electric field of the first pass-through light is parallel to the orientation of the electric field of the third pass-through light (indicated by open arrows), and the orientation of the electric field of the second pass-through light is parallel to the orientation of the electric field of the fourth pass-through light (indicated by open arrows). The extinction ratio of each of the polarizers is preferably at least three, more preferably at least ten. The extinction ratio associated with the first polarizer 121 means the ratio between the two light components contained in the light having passed therethrough (that is, the ratio of the light component whose electric field is oriented in the horizontal direction to the light component whose electric field is oriented in the vertical direction). Similarly, the extinction ratio associated with the second polarizer 122 means the ratio between the two light components contained in the light having passed through the second polarizer 122 (that is, the ratio of the light component whose electric field is oriented in the vertical direction to the light component whose electric field is oriented in the horizontal direction).

The first pass-through light having passed through the first polarizer 121 passes through the third polarizers 131 and reaches the imaging device 140. Similarly, the second pass-through light having passed through the second polarizer 122 passes through the fourth polarizers 132 and reaches the imaging device 140. The image processor 170 produces stereoscopic images based on the first pass-through light (third pass-through light) and the second pass-through light (fourth pass-through light) having reached the imaging device 140, and the produced stereoscopic images have a base line length of binocular parallax that is equal to the distance between the center of gravity BC1 of the first polarizer 121 and the center of gravity BC2 of the second polarizer 122.

### [Example of Arrangement of Polarizers at Imaging Device]

FIGS. 3A and 3B show an example of the arrangement of the third polarizers 131 and the fourth polarizers 132, which form the imaging device polarizing unit 130 in the first embodiment of the present disclosure. In FIGS. 3A and 3B, the description will be made with reference to a case where the pixels in the imaging device 140 are disposed in a Bayer arrangement. FIG. 3A is an enlarged view of part of the pixels in the imaging device 140, and FIG. 3B shows all the pixels in the imaging device 140 (note that part of the pixels are omitted). In FIGS. 3A and 3B, the positions on the imaging device 140 where the third polarizers 131 and the fourth polarizers 132 are disposed are identified by characters (“third polarizer” and “fourth polarizer”) placed in upper portions of the figures. FIG. 3B shows a case where the imaging device 140 has two million pixels.

The Bayer arrangement is a pixel arrangement in which a basic block (group of pixels) formed of two pixels (in horizontal direction) by two pixels (in vertical direction) is periodically disposed. In FIGS. 3A and 3B, a thick-line square represents each area corresponding to the basic block, and the dotted line represents the boundary between the pixels in the basic block. In the basic block, two G (green) pixels are disposed along one diagonal, and an R (red) pixel and a B (blue) pixel are disposed along the other diagonal. Each G pixel is formed of a photodetector that detects green light. Each R pixel is formed of a photodetector that detects red light. Each B pixel is formed of a photodetector that detects blue light. In FIGS. 3A and 3B, each pixel is diagrammatically expressed by a square labeled with a character representing the type of the pixel (G, R, or B).

A third polarizers 131 corresponds to a column of pixels arranged along the vertical direction (Y-axis direction) (two pixels in the horizontal direction), as shown in FIGS. 3A and 3B. Adjacent to the column of pixels in the horizontal direction (X-axis direction) is disposed a fourth polarizer 132, which corresponds to a column of pixels arranged along the vertical direction (two pixels in the horizontal direction). The third polarizer 131 and the fourth polarizer 132 are thus alternately disposed along the horizontal direction. The vertical length of the third polarizers 131 and the fourth polarizers 132, which generally extend in the vertical direction, can be substantially equal to the vertical length of the imaging device 140. Similarly, the horizontal length of the third polarizers 131 and the fourth polarizers 132 can be substantially equal to the horizontal length of two pixels in the imaging device 140.

The configuration described above allows a strip of image extending in the vertical direction and produced based on light primarily having the P-wave component (image for right vision) and a strip of image extending in the vertical direction and produced based on light primarily having the S-wave component (image for left vision) to be alternately produced along the horizontal direction.

As described above, in the imaging apparatus 100, the pupil polarizing unit 120 (first polarizer 121 and second polarizer 122), which produces light fluxes polarized in directions perpendicular to each other, is disposed in the position of the diaphragm 113. The light incident on the lens system 110 is divided by the pupil polarizing unit 120 (first polarizer 121 and second polarizer 122) into light corresponding to the right side of the pupil and light corresponding to the left side of the pupil. Using the distance between the centers of gravity of the areas of the light fluxes passing through the right and left sides of the pupil (pass-through figures) as the base line length of binocular parallax, the imaging device polarizing unit 130 (third polarizer 131 and fourth polarizer 132) disposed in the position of the imaging device 140 produces an image for right vision and an image for left vision separately, and the imaging device 140 captures the images simultaneously. The third polarizers 131 and the fourth polarizers 132 in the position of the imaging device 140 are alternately disposed on a two-pixel line basis in parallel to the right/left division axis of the pupil polarizing unit 120 (first polarizer 121 and second polarizer 122).

As described above, the first polarizer 121 and the second polarizer 122 are two polarizers that are disposed in the vicinity of the diaphragm 113 and polarize the light from a subject, and the polarization directions of polarizers are perpendicular to each other. Now, let a first direction (direction of parallax associated with stereoscopic images produced by imaging apparatus 100, for example) be the direction along which the first polarizer 121 and the second polarizer 122 are connected to each other (horizontal direction (X-axis direction)). In this case, the third polarizers 131 are disposed, alternating with the fourth polarizers 132, in a photodetection plane of the imaging device 140 along a direction perpendicular to the first direction (second direction (vertical direction (Y-axis direction)) in such a way that the third polarizers 131 extend in the second direction and the polarization direction thereof is parallel to that of the first polarizer 121. The fourth polarizers 132 are disposed, alternating with the third polarizers 131, in the photodetection plane of the imaging device 140 along the second direction in such a way that the fourth polarizers 132 extend in the second direction and the polarization direction thereof is parallel to that of the second polarizer 122. The first polarizer 121 and the second polarizer 122 are disposed adjacent to each other on opposite sides of the second direction as a boundary in the vicinity of the diaphragm 113 in a single optical system (lens system 110).

The imaging device 140 has pixels arranged in a matrix identified by the first and second directions, and the pixels are disposed in a primary color Bayer arrangement. In this case, the third polarizers 131 and the fourth polarizers 132 are, for example, alternately disposed on a predetermined arrangement unit basis, the predetermined arrangement unit being a line extending in the second direction and corresponding to two pixels in the first direction in the imaging device 140.

In the first embodiment of the present disclosure, in which the description is made with reference to the Bayer arrangement according to which the pixels in the imaging device 140 are disposed, other arrangements can be used in the first embodiment of the present disclosure. For example, an interline arrangement, a G-stripe/RB checker arrangement, a G-stripe/RB complete checker arrangement, a checker complementary color arrangement, a stripe arrangement, an oblique stripe arrangement, a primary color difference arrangement, and a field color difference sequential arrangement can also be used in the first embodiment of the present disclosure. Further, for example, a frame color difference sequential arrangement, a MOS arrangement, a modified MOS arrangement, a frame interleave arrangement, and a field interleave arrangement can be used in the first embodiment of the present disclosure.

### [Example of Relationship Between Stream of Light and Images Produced by Light]

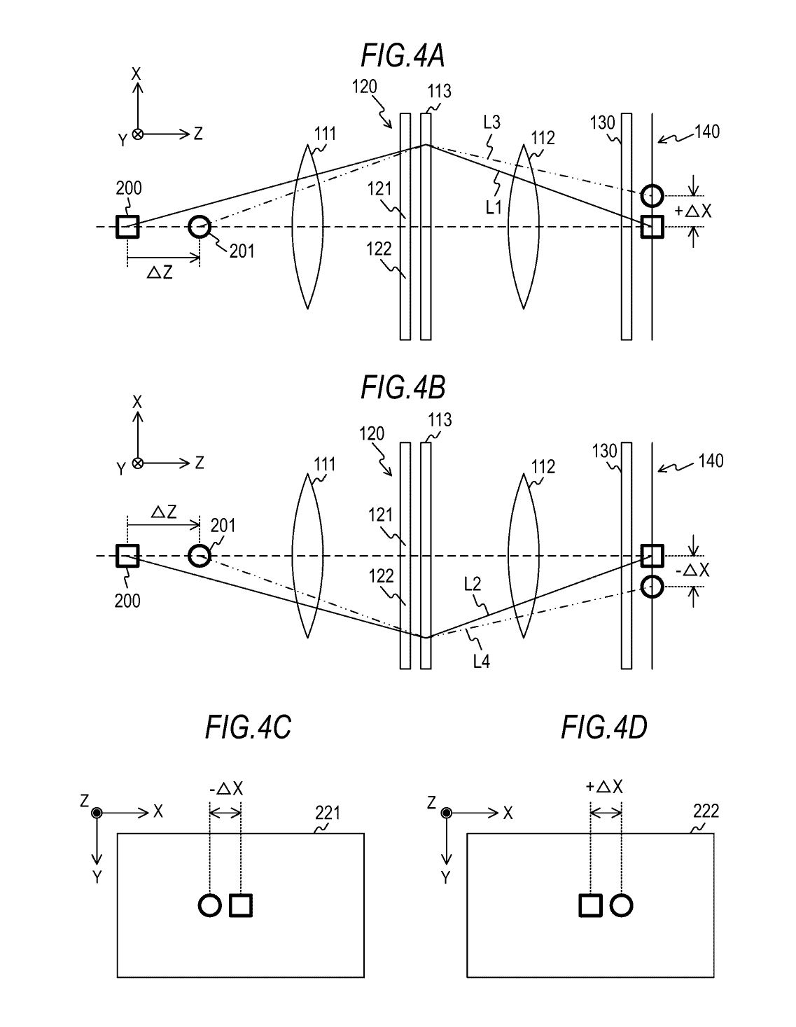

FIGS. 4A to 4D diagrammatically show the relationship between the stream of light through the lens system 110, the pupil polarizing unit 120, and the imaging device polarizing unit 130 and images produced by the light in the first embodiment of the present disclosure.

FIG. 4A shows the stream of light that passes through the lens system 110, the first polarizer 121 in the pupil polarizing unit 120, and the third polarizer 131 in the imaging device polarizing unit 130 and reaches the imaging device 140. FIG. 4B shows the stream of light that passes through the lens system 110, the second polarizer 122 in the pupil polarizing unit 120, and the fourth polarizer 132 in the imaging device polarizing unit 130 and reaches the imaging device 140.

FIG. 4C shows an image formed by the light shown in FIG. 4B on the imaging device 140 (image for left vision 221). FIG. 4D shows an image formed by the light shown in FIG. 4A on the imaging device 140 (image for right vision 222).

In FIGS. 4A and 4B, the description will be made with reference to a case where the lens system 110 focuses a square object 200 and a circular object 201 is positioned away from the square object 200 toward the lens system 110. In this case, an image of the square object 200 is focused and formed on the imaging device 140. In contrast, an image of the circular object 201 is formed on the imaging device 140 but is not focused.

Specifically, the image of the circular object 201 is formed on the imaging device 140 in a position apart rightward from the image of the square object 200 by a distance (+Δx), as shown in FIG. 4A. Further, the image of the circular object 201 is formed on the imaging device 140 in a position apart leftward from the image of the square object 200 by a distance (−Δx), as shown in FIG. 4B. The distance (2×Δx) is therefore information on the depth of the circular object 201.

That is, the amount and direction of blur of an image of an object positioned on the near side of the square object 200 toward the imaging apparatus 100 (circular object 201) differ from the amount and direction of blur of an image of an object positioned on the far side of the square object 200 away from the imaging apparatus 100. Further, the amount and direction of blur of an image of the circular object 201 change in accordance with the distance between the square object 200 and the circular object 201. Resultant stereoscopic images have a base line distance of binocular parallax equal to the distance between the centers of gravity of the areas of the first polarizer 121 and the second polarizer 122 in the pupil polarizing unit 120.

Based on the thus produced image for left vision 221 and image for right vision 222, stereoscopic images can be produced in a known way. A planar image (two-dimensional image (that is, non-stereoscopic image)) can also be produced by combining the image data for right vision and the image data for left vision.

The imaging device 140 produces an electric signal for producing the image data for right vision based on the first pass-through light having passed through the third polarizers 131 and reached the imaging device 140. Similarly, the imaging device 140 produces an electric signal for producing the image data for left vision based on the second pass-through light having passed through the fourth polarizers 132 and reached the imaging device 140. The imaging device 140 outputs the thus produced electric signals simultaneously or alternately in time sequence. The image processor 170 performs image processing on the outputted electric signals (electric signals outputted from the imaging device 140 and used to produce image data for right vision and image data for left vision). The image processor 170 then records the image data having undergone the image processing as the image data for right vision and the image data for left vision in the storage unit 180.

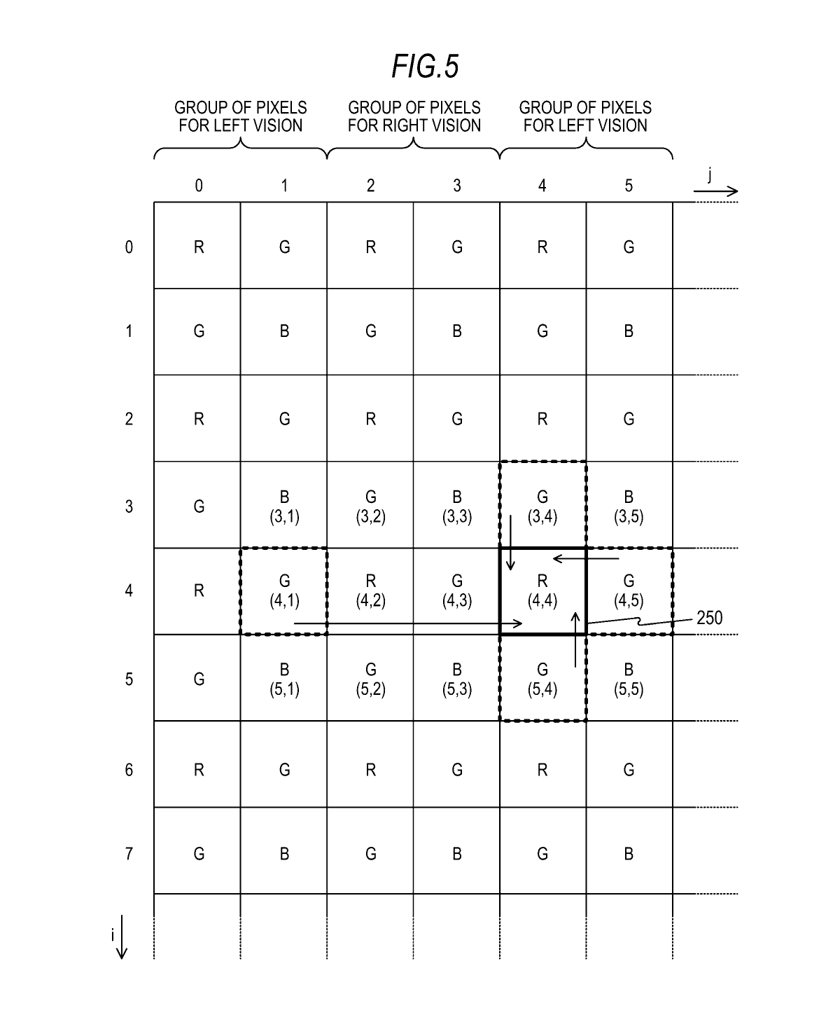

The image for right vision and the image for left vision described above, which have been thinned out in the horizontal direction, may not allow stereoscopic images to be displayed appropriately. To produce image data for right vision and image data for left vision that allow stereoscopic images to be displayed appropriately, the image processor 170 performs demosaicing and interpolation (interpolation based, for example, on super-resolution processing) on the electric signals. The image processor 170 can thus produce image data for right vision and image data for left vision that allow stereoscopic images to be displayed appropriately. FIG. 5 shows an example of the interpolation. Further, for example, the image processor 170 can perform other kinds of image processing based on the image data for right vision and the image data for left vision. For example, parallax can be enhanced and optimized by using a parallax detection technique for producing a disparity map based on stereo matching and a parallax control technique for controlling parallax based on the disparity map.

### [Example of Demosaicing]

FIG. 5 diagrammatically shows image processing (demosaicing) performed by the image processor 170 in the first embodiment of the present disclosure. In FIG. 5, a description will be made of an example of how to produce a signal value of a G pixel in an image for left vision among the pixels arranged in the Bayer arrangement to form the imaging device 140. It is noted that no description will be made of white balance, exposure, contrast, chroma, sharpness, and other kinds of image quality adjustment, color management and other kinds of image signal processing, software processing, format conversion, and other kinds of processing, each of which is typical digital image processing.

In typical demosaicing, for example, the average of electric signals from pixels of the same color close to one another is used. In the first embodiment of the present disclosure, however, the group of pixels (column of pixels) for producing image data for right vision and the group of pixels (column of pixels) for producing image data for left vision are alternately repeated. For this reason, using values of pixels close to one another like typical demosaicing may disadvantageously not provide correct image data. To address the problem, in the first embodiment of the present disclosure, the demosaicing is performed in consideration of a result of judgment whether an electric signal from a pixel to be referred to is associated with image data for right vision or image data for left vision.

In FIG. 5, the square corresponding to each pixel is labeled with the type of the pixel (G, R, or B) and the position of the pixel (i, j). The position of a pixel (i, j) is expressed by an identification number in the X-axis direction (shown in upper portion of FIG. 5) and an identification number in the Y-axis direction (shown in left portion of FIG. 5). Further, in the Bayer arrangement shown in FIG. 5, a pixel 250 surrounded by a thick line (position (4,4)) is assumed to be an R pixel. For example, to produce a G-pixel signal value g′ corresponding to the pixel 250, the following Expression (1) is computed.

g′(4,4)=(g(3,4)+g(4,5)+g(5,4)+g(4,1)×W3)/(3.0+W3) (1)

The term g′ (i, j) in the left-hand side of Expression (1) means a G-pixel signal value in the pixel position (i, j). Similarly, the term g (i,j) in the right-hand side means an electric signal value of the G-pixel in the pixel position (i, j). Further, the denominator of “3.0” in the right-hand side represents a weight for the distance (W1) between a pixel of interest (pixel 250 (position (4,4))) and three G pixels (positions (3,4), (4,5), and (5,4)) adjacent thereto. That is, the denominator of “3.0” in the right-hand side corresponds, when the distance (W1) to each of the three G pixels (positions (3,4), (4,5), and (5,4)) is a predetermined value (1.0, for example) and the reciprocal of the distance is a weight, to the sum of the weights. In FIG. 5, the three G pixels (reference pixels) adjacent to the pixel of interest and the G pixel (reference pixel) apart from the pixel of interest by three pixels are surrounded by dotted-line squares.

The value W3 in the denominator and the numerator of the right-hand side represents a weight for the value of an electric signal from the G pixel (position (4,1)) apart from the pixel of interest by three pixels. In this example, W3 is “⅓”.

Now, Expression (1) is generalized to the following Expressions (2) and (3). Expression (2) is used to calculate a signal value for i of an even number (G pixel signal value corresponding to the position of an R pixel). Expression (3) is used to calculate a signal value for i of an odd number (G pixel signal value corresponding to the position of a B pixel).

g′(i,j)=(g(i−1,j)×W1+g(i,j+1)×W1+(g(i+1,j)×W1+g(i,j−3)×W3)/(W1×3.0+W3) (2)

g′(i,j)=(g(i−1,j)×W1+g(i,j+1)×W1+(g(i−1,j)×W1+g(i,j+3)×W3)/(W1×3.0+W3) (3)

In the above Expressions, for example, W1 and W3 can be set at 1.0 and ⅓, respectively.

The above example has been described with reference to the case where a G pixel signal value in the position of an R pixel is produced. The demosaicing can be similarly performed in a case where other pixel signal values are produced.

The demosaicing thus allows a pixel signal value in the position of each pixel to be produced, but each image has been sort of thinned out in this stage as described above. It is therefore necessary to produce a pixel signal value in an area where no pixel signal value is present by using interpolation, which can be any known method, such as a method using the average of the values of pixels close to the pixel of interest. The interpolation may be performed concurrently with the demosaicing. In the vertical direction, the image quality is perfectly maintained, and decrease in resolution of an entire image and other degradation in image quality are relatively low.

### [Example of Configuration of Imaging Device and Imaging Device Polarizing Unit]

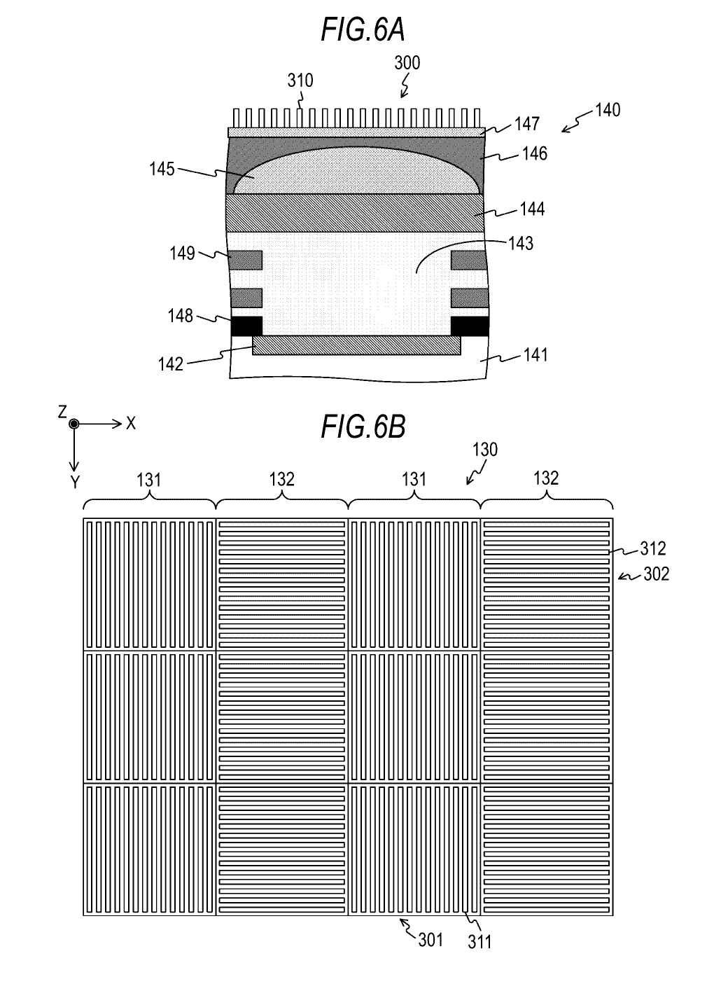

FIGS. 6A and 6B diagrammatically show the imaging device 140 and the imaging device polarizing unit 130 in the first embodiment of the present disclosure.

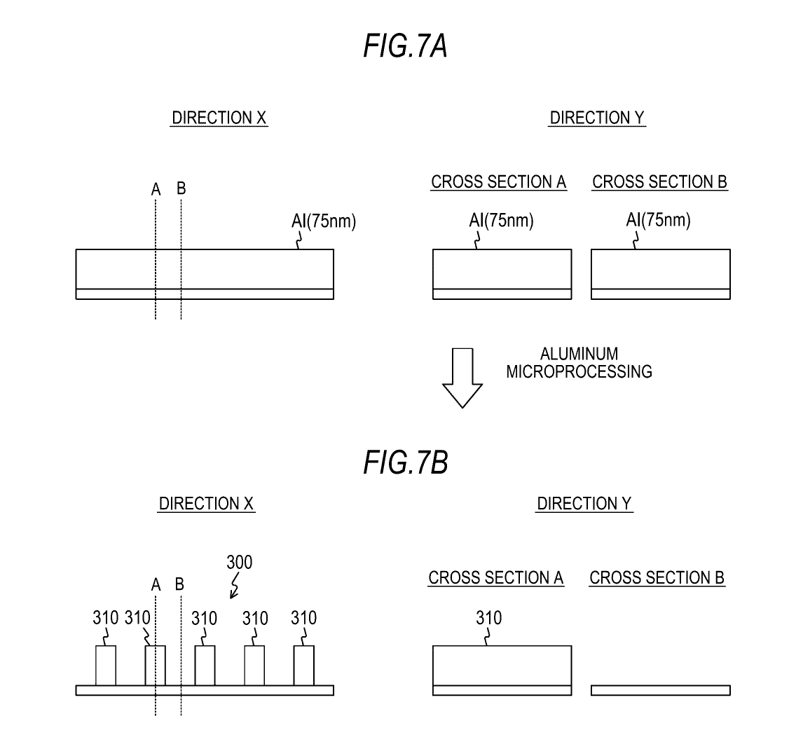

FIGS. 7A and 7B schematically show a semiconductor process procedure according to which a wire-grid polarizer 300 is formed in the first embodiment of the present disclosure.

FIG. 6A is a schematic cross-sectional view of the imaging device 140 and the imaging device polarizing unit 130. FIG. 6B schematically shows part of the arrangement of the wire-grid polarizers 300 (third polarizers 131 and fourth polarizers 132), which form the imaging device polarizing unit 130.

The imaging device 140 includes a substrate (silicon semiconductor substrate) 141, photoelectric conversion devices 142, a first planarizing film 143, a color filter 144, and on-chip lenses 145. A second planarizing film 146, an inorganic insulating primary layer 147, and the wire-grid polarizers 300 are stacked on the on-chip lenses 145.

The photoelectric conversion devices 142 are formed in the substrate 141. The first planarizing film 143, the color filter 144, the on-chip lenses 145, the second planarizing film 146, the inorganic insulating primary layer 147, and the wire-grid polarizers 300 are stacked on the photoelectric conversion devices 142. Each of the wire-grid polarizers 300 forms each of the third polarizers 131 and the fourth polarizers 132. The order in which the on-chip lenses, the color filter, and the wire-grid polarizers are stacked can be changed as appropriate.

The on-chip lenses 145 are planarized by the second planarizing film 146 deposited on the on-chip lenses 145, and a WGP processing stopper film (inorganic insulating primary layer 147) for forming the wire-grid polarizers 300 is deposited on the second planarizing film 146. The wire-grid polarizers 300 can be formed on the WGP processing stopper film based on aluminum microprocessing in a semiconductor step. FIGS. 7A and 7B show an example of the WGP formation semiconductor process.

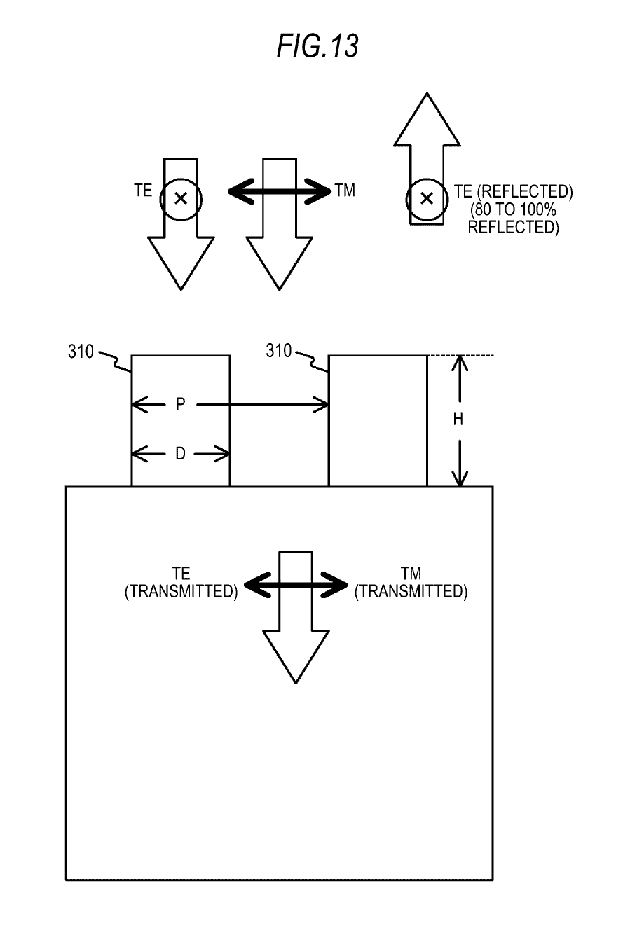

Wires 310 that form each of the wire-grid polarizers 300 are made, for example, of aluminum (Al) or an aluminum alloy. The interval between the wires 310 and the duty (=wire width divided by interval) thereof, the height thereof, and other parameters thereof will be described in detail with reference to FIGS. 13 to 16A and 16B.

In FIG. 6B, an area corresponding to the basic block (group of pixels formed of two pixels (in horizontal direction) by two pixels (in vertical direction) shown in FIGS. 3A and 3B) is expressed by a soli-line square. Each of the wires 310 is expressed by a rectangle elongated in the horizontal or vertical direction. That is, a plurality of wires 310, which form each of the wire-grid polarizers 300, extend in parallel to the horizontal or vertical direction.

Specifically, in a wire-grid polarizer 301, which forms each of the third polarizers 131, wires 311 extend in parallel to the vertical direction. In a wire-grid polarizer 302, which forms each of the fourth polarizers 132, wires 312 extend in parallel to the horizontal direction. The direction in which the wires 310 extend is a light absorption axis in each of the wire-grid polarizers 300, and the direction perpendicular to the direction in which the wires 310 extend is a light transmission axis in each of the wire-grid polarizers 300.

### [Example of Stereoscopic Image Generation]

Recording of stereoscopic images will next be described. Since stereoscopic images are formed of a plurality of images (image for right vision and image for left vision, for example), the plurality of images may not be recorded by using a format according to which planar images (what is called 2D images) are recorded (transportation format) unless the size of the images are changed. To store stereoscopic images by using a recording format for planar images, the plurality of images are often handled as a single image by thinning out or otherwise compressing image signals carrying the images.

Known recording formats are, for example, a side by side scheme, a top and bottom scheme, a line by line scheme, a checkerboard scheme, a frame sequential scheme, and an L+ parallax scheme. Among the recording formats described above, the side by side scheme, the top and bottom scheme, the line by line scheme, and the checkerboard scheme cause one-half image data carried by right and left image signals to be lost but can convert the size thereof into an image size of related art. For this reason, these schemes are widely used in broadcasting networks of related art. In particular, the side by side scheme is also employed in CS (communications satellite) digital broadcasting, BS (broadcasting satellite) digital broadcasting, and other types of broadcasting. That is, the side by side scheme is the most widely used in 3D video transportation.

In the frame sequential scheme and the L+ parallax scheme, each of which is a high definition-oriented scheme, the size of a stored image is larger than the size of a full-HD (full high definition) image. These schemes are therefore expected to be employed, for example, in communication between a reproducing apparatus and a display apparatus that will be available in the near future.

In view of the situations described above, in the first embodiment of the present disclosure, image data produced by the imaging device 140 are recorded by using the side by side scheme by way of example.

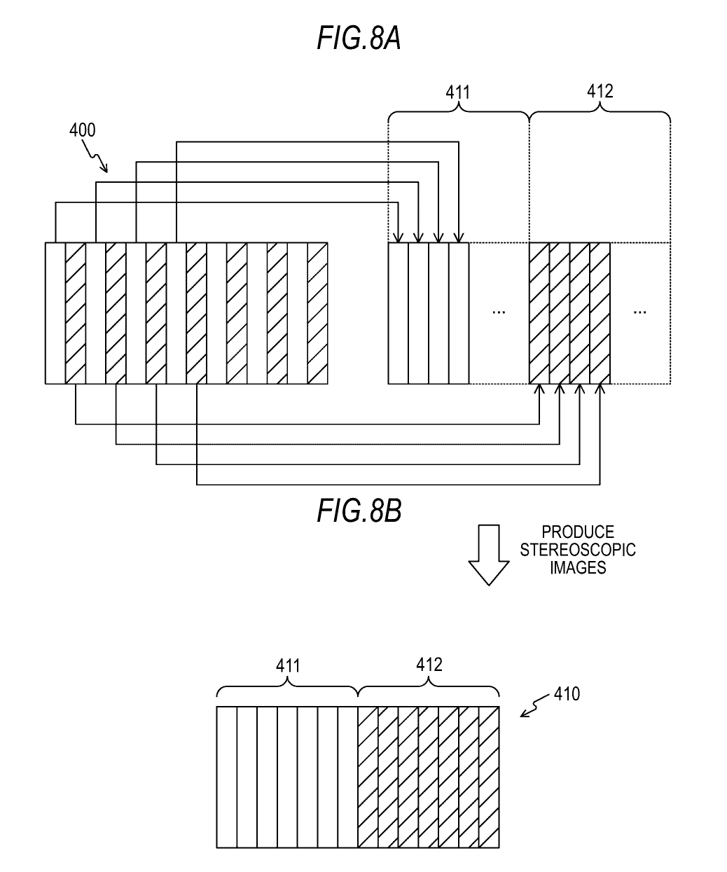

FIGS. 8A and 8B diagrammatically show an example of an image processing method carried out when the image processor 170 produces images to be recorded in the first embodiment of the present disclosure.

FIG. 8A shows an example of an image processing method carried out when image data to be recorded 410 are produced from RAW data 400. Suppose that the RAW data 400 are formed of rectangles. Open rectangles represent image data (image data corresponding to two pixels in horizontal direction) produced by the light having passed through the first polarizer 121 and the third polarizers 131, and hatched rectangles represent image data (image data corresponding to two pixels in horizontal direction) produced by the light having passed through the second polarizer 122 and the fourth polarizers 132. In FIGS. 8A and 8B, some of the lines (open rectangles and hatched rectangles) are omitted in the horizontal direction for ease of description.

The image processor 170 converts image signals (image data) read from the imaging device 140 into image data that conform to the side by side scheme (image data to be recorded 410) by rearranging the image signals on a two-pixel line basis, as indicated by the arrows in FIG. 8A. That is, the image data to be recorded 410 shown in FIG. 8B are produced by rearranging the raw image data in such a way that images passing through the right side of the pupil and images passing through the left side of the pupil are separated from each other. The following image processing will not be described because each of the thus rearranged images can be handled as a typical full-HD image.

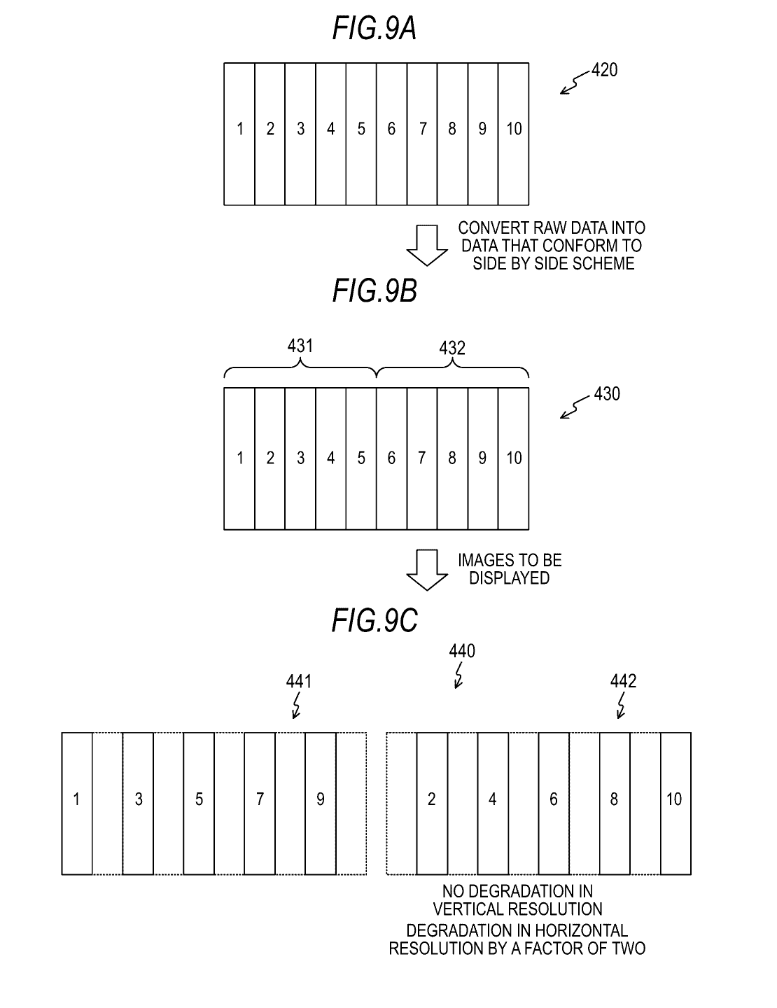

FIGS. 9A to 9C diagrammatically show the relationship between image data to be recorded 430 having been produced by the image processor 170 and stereoscopic images to be displayed 440 in the first embodiment of the present disclosure.

FIG. 9A diagrammatically shows RAW data 420 produced by the imaging device 140. The rectangles that form the RAW data 420 represent image data produced by the light having passed through the pupil polarizing unit 120 and the imaging device polarizing unit 130 and are labeled with identification numbers 1 to 10.

FIG. 9B diagrammatically shows image data obtained by converting the RAW data 420 into image data that conforms to the side by side scheme (image data to be recorded 430). A method for converting the RAW data 420 into the image data to be recorded 430 is the same as the conversion method shown in FIG. 8A, and no description thereof will therefore be made.

As described above, in the first embodiment of the present disclosure, since only the data from the groups of pixels (two-pixel line) in the vertical direction are so rearranged that the RAW data 420 are converted into image data that conform to the side by side scheme (image data to be recorded 430), the vertical resolution is maintained.

Consider now a case where the polarizers (horizontal lines) in the imaging device polarizing unit are alternately disposed in the vertical direction or the polarizers in the imaging device polarizing unit are disposed in a checkerboard pattern and image data are recorded based on the side by side scheme. In either case, the vertical and horizontal resolution degrades by at least a factor of two. In contrast, in the first embodiment of the present disclosure, the horizontal resolution degrades by a factor of two but the vertical resolution does not degrade. The first embodiment of the present disclosure therefore prevents degradation in image quality resulting from the conversion into image data that conforms to the side by side scheme (that is, degradation in horizontal and vertical resolution by at least a factor of two).

When stereoscopic images are recorded as described above, a subject can be reproduced in greater detail than in a case where the polarizers in the imaging device polarizing unit (horizontal lines) are alternately disposed in the vertical direction. That is, when the third polarizers 131 and the fourth polarizers 132 (vertical lines) in the imaging device polarizing unit 130 are alternately disposed in the horizontal direction, the vertical resolution does not degrade, whereby degradation in quality of stereoscopic images can be reduced.

FIG. 9C diagrammatically shows stereoscopic images to be displayed 440, which are used to display the image data to be recorded 430 shown in FIG. 9B. The stereoscopic images 440 are formed of an image for left vision 441 and an image for right vision 442. Areas corresponding to the dotted-line rectangles (areas that are not labeled with identification numbers 1 to 10) undergo interpolation or other kinds of processing before reproduced. The stereoscopic images having undergone the interpolation are then displayed.

In accordance with the procedure described above, the image processor 170 processes the image data produced by the imaging device 140 in such a way that image data produced based on the light having passed through the first polarizer 121 and the third polarizers 131 (first pass-through light) are handled as first image data (image data for right vision), and that image data produced based on the second pass-through light having passed through the second polarizer 122 and the fourth polarizers 132 are handled as second image data (image data for left vision). The first and second image data are used to display stereoscopic images.

The image processor 170 rearranges the image data produced by the imaging device 140 on a predetermined unit basis, the predetermined unit being a line extending in the second direction (vertical direction (Y-axis direction)) and corresponding to the third polarizer 131 and the fourth polarizer 132 to produce the first and second image data.

In other words, the image processor 170 produces the first and second image data as image data to be recorded in the storage unit 180 based on a predetermined recording format (side by side scheme, for example).

The above example has been described with reference to the case where image data to be recorded are produced by rearranging image signals read from the imaging device 140, but other image conversion methods may be used. For example, when image signals are read from the imaging device 140, the lines in one image that forms stereoscopic images (image for left vision, for example) maybe sequentially read on two-pixel basis, and the lines in the other image (image for right vision, for example) may then be sequentially read on two-pixel basis. The thus read image data can be used to produce image data that conform to the side by side scheme.

That is, the image processor 170 can handle the image data produced by the imaging device 140 as follows: image data sequentially read on a predetermined unit basis, the predetermined unit being a line extending in the second direction and corresponding to the third polarizer 131, are handled as first image data and image data sequentially read on a predetermined unit basis, the predetermined unit being a line extending in the second direction and corresponding to the fourth polarizer 132, are handled as second image data.

### [Example of Arrangement of Polarizers at Imaging Device]

Recent imaging devices (image sensors) have an increasingly greater number of pixels, and some imaging devices having been recently developed have ten million pixels or greater. The number of pixels from which video images are formed, however, is about two millions in a full-HD image, and adjacent pixels are typically summed into a single pixel in many cases when they are used to form video images.

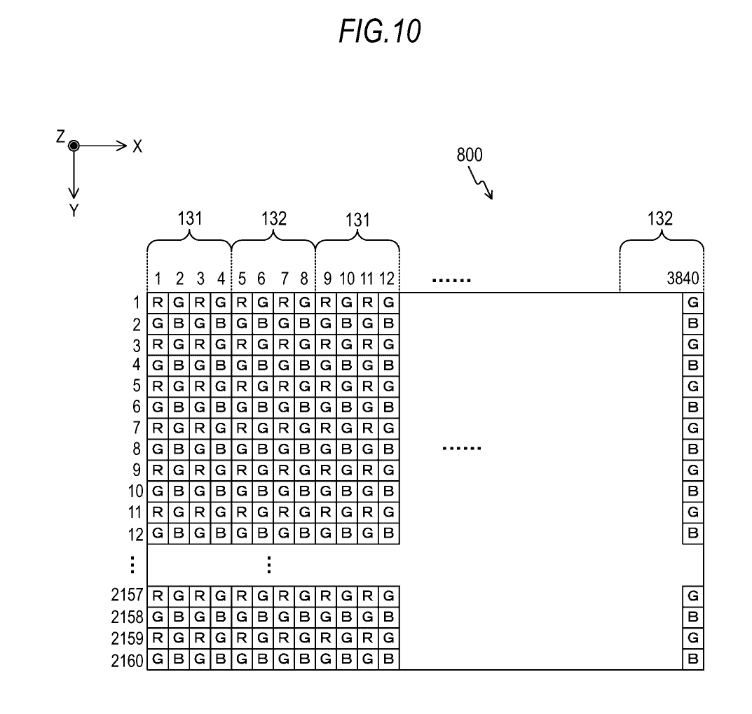

To this end, an imaging device having such a large number of pixels can have polarizers disposed every predetermined unit in advance in accordance with the number of pixels to be summed, the predetermined unit being those in the Bayer arrangement multiplied by N (N is an integer greater than or equal to one). FIG. 10 shows an example of the arrangement.

FIG. 10 shows a variation of the arrangement of the polarizers that form the imaging device polarizing unit 130 in the first embodiment of the present disclosure. FIG. 10 shows an example of the arrangement of the polarizers used with an imaging device 800 that produces image signals by adding pixel values.

In the example shown in FIG. 10, the polarizers (third polarizers 131 and fourth polarizers 132) are arranged every predetermined unit in the horizontal direction in the imaging device 800 having a large number of pixels, the predetermined unit being the basic block (group of pixels formed of two pixels (in horizontal direction) by two pixels (in vertical direction) shown in FIGS. 3A and 3B) multiplied by two. FIG. 10 shows all the pixels (note that part thereof is omitted) in the imaging device 800, as in FIG. 3B. Further, in FIG. 10, the positions on the imaging device 800 where the third polarizers 131 and the fourth polarizers 132 are disposed are identified by the characters (“third polarizer 131” and “fourth polarizer 132”) placed in an upper portion of FIG. 10. In FIG. 10, the imaging device 800 has eight million pixels by way of example.

As shown in FIG. 10, one third polarizer 131 and one fourth polarizer 132 can be alternately disposed along a vertical line (group of pixels) formed of N pixels (N=2n (n is a natural number ranging from 1 to 5)) in the horizontal direction.

That is, the third polarizers 131 and the fourth polarizers 132 are, for example, alternately disposed on a predetermined arrangement unit basis, the predetermined arrangement unit being a line extending in the second direction and corresponding to four pixels in the first direction in the imaging device 140.

The image processor 170 sums the image data produced by the imaging device 140 on a predetermined unit basis, the predetermined unit being a line extending in the second direction and corresponding to the third polarizer 131 and the fourth polarizer 132, and then rearranges the summed image data. The image processor 170 can produce first image data and second image data by rearranging the summed image data. The summation may be performed by the image processor 170 or the imaging device 140.

The above example has been described with reference to the case where summed image signals are so rearranged that image data to be recorded are produced, but other image conversion methods may be used. For example, the image processor 170 may sum image data on a predetermined unit basis, the predetermined unit being a line extending in the second direction and corresponding to the third polarizer 131, and then handle sequentially read image data (summed image data) as the first image data. Similarly, the image processor 170 may sum image data on a predetermined unit basis, the predetermined unit being a line in the second direction and corresponding to the fourth polarizer 132, and then handle sequentially read image data (summed image data) as the second image data.

### [Example of Operation of Imaging Apparatus]

The operation of the imaging apparatus 100 in the first embodiment of the present disclosure will next be described with reference to the drawings.

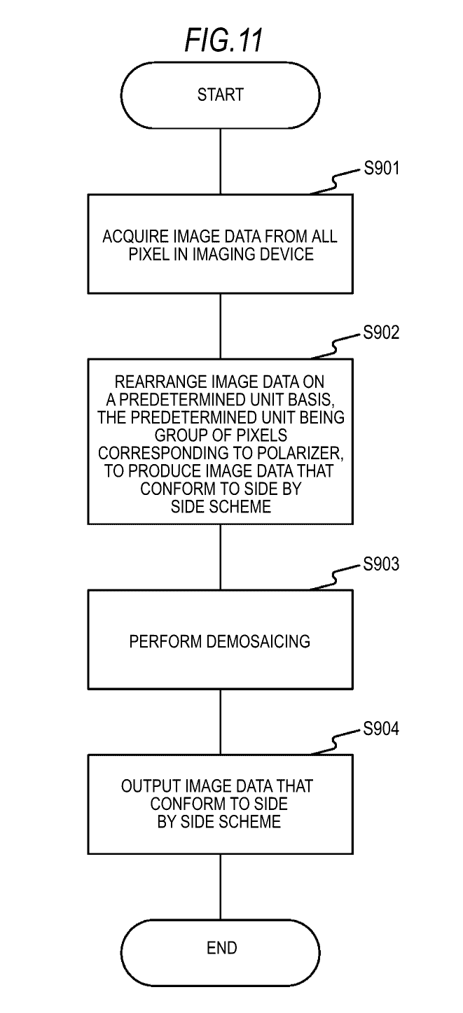

FIG. 11 is a flowchart showing an example of an image processing procedure performed by the imaging apparatus 100 in the first embodiment of the present disclosure. In the example, the image processor 170 acquires image data from all the pixels in the imaging device 140 and rearranges the acquired image data.

The image processor 170 first acquires image data from all the pixels in the imaging device 140 (step S901). Step S901 is an example of the acquisition step set forth in the appended claims.

The image processor 170 then rearranges the image data acquired from the imaging device 140 (step S902). That is, the image processor 170 rearranges the image data on a predetermined unit basis, the predetermined unit being a group of pixels corresponding to each of the third polarizer 131 and the fourth polarizer 132, to produce image data that conform to the side by side scheme (step S902). Step S902 is an example of the image processing step set forth in the appended claims.

The image processor 170 then performs demosaicing on the image data that conform to the side by side scheme (step S903). The image processor 170 then outputs the image data that conform to the side by side scheme and have undergone the demosaicing (step S904). For example, the image processor 170 outputs the image data that conform to the side by side scheme and have undergone the demosaicing and stores the image data in the storage unit 180 (step S904).

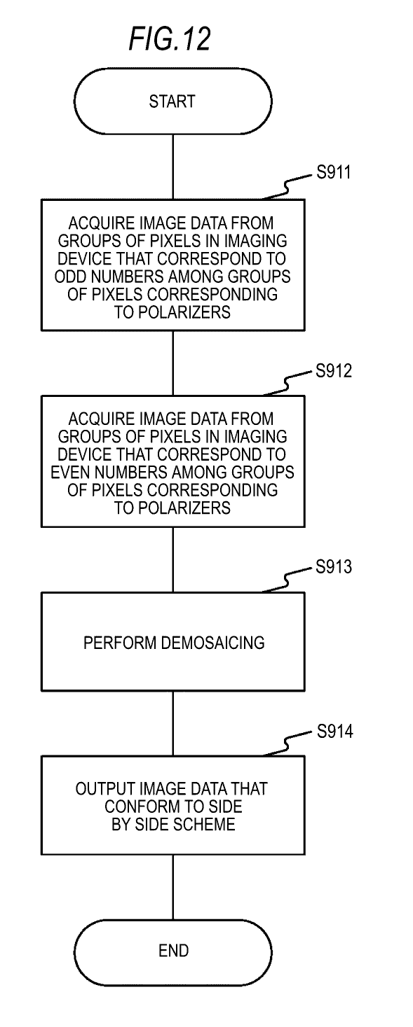

FIG. 12 is a flowchart showing another example of the image processing procedure performed by the imaging apparatus 100 in the first embodiment of the present disclosure. In the example, image data are acquired from the imaging device 140 on a predetermined unit basis, the predetermined unit being images that form stereoscopic images.

The image processor 170 first acquires image data from groups of pixels corresponding to the third polarizers 131 (step S911). The image processor 170 then acquires image data from groups of pixels corresponding to the fourth polarizers 132 (step S912). Since image data are acquired from the imaging device 140 on a predetermined unit basis, the predetermined unit being images that form stereoscopic images as described above, the image processor 170 can produce image data that conform to the side by side scheme without having to rearrange the image data. Steps S911 and S912 are examples of the acquisition step set forth in the appended claims. Steps S911 and S912 are also examples of the image processing step set forth in the appended claims.

The image processor 170 then performs demosaicing on the image data that conform to the side by side scheme (step S913). The image processor 170 then outputs the image data that conform to the side by side scheme and have undergone the demosaicing (step S914). For example, the image processor 170 outputs the image data that conform to the side by side scheme and have undergone the demosaicing and stores the image data in the storage unit 180 (step S914).

In the first embodiment of the present disclosure, the side by side scheme, which is the most typical 3D video transportation scheme, is used, as described above. The vertical resolution of the image data produced by the imaging device 140 is therefore maintained when the image data are converted into a video signal that conforms to the side by side scheme, whereby degradation in quality of stereoscopic images can be reduced.

Further, stereoscopic images (3D video images) can be produced only by rearranging image data, which is relatively simple signal processing. Moreover, after the rearrangement of the right and left images, a typical HD signal processing algorithm can be used without any modification, whereby the scale of the circuit can be reduced.

### [Example of Wire-Grid Polarizer]

The exterior structure and the operation of the wire-grid polarizer (WGP) in the first embodiment of the present disclosure will next be summarized.

For example, metal (aluminum) ribs are so formed that each of the ribs has a line width of several tens of nanometers, which is sufficiently smaller than the wavelength of light, and that the ribs are arranged at an interval of one hundred and several tens of nanometers. It is known that the thus formed ribs work as a reflective polarizing plate having excellent polarization separation characteristics, specifically, reflecting a polarization component parallel to the ribs and transmitting a polarization component perpendicular to the ribs.

### [Shape and Characteristics of Wire-Grid Polarizer]

FIG. 13 schematically shows the interval, the height, and the width of the wire-grid polarizer in the first embodiment of the present disclosure. In FIG. 13, let P be the interval between the wires 310, which form the wire-grid polarizer, H be the height of the wires 310, and D be the width of the wires 310 (wire width). In the following example, behaviors of an index are checked by individually changing the parameters described above based on the structure shown in FIG. 13.

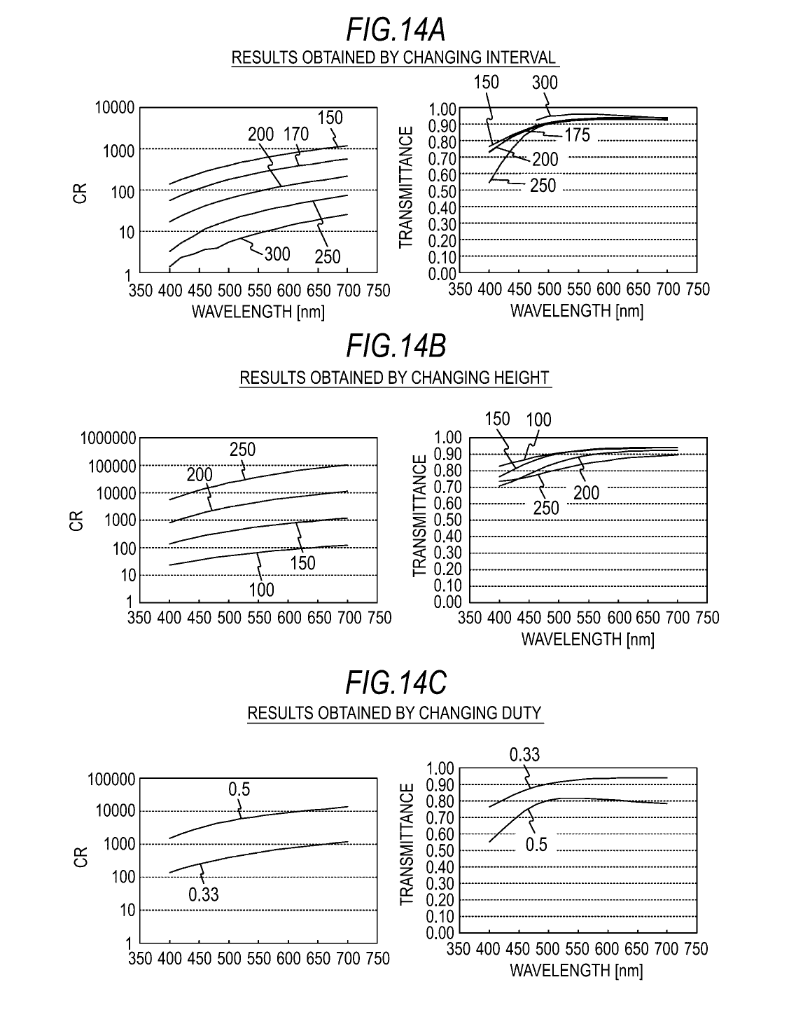

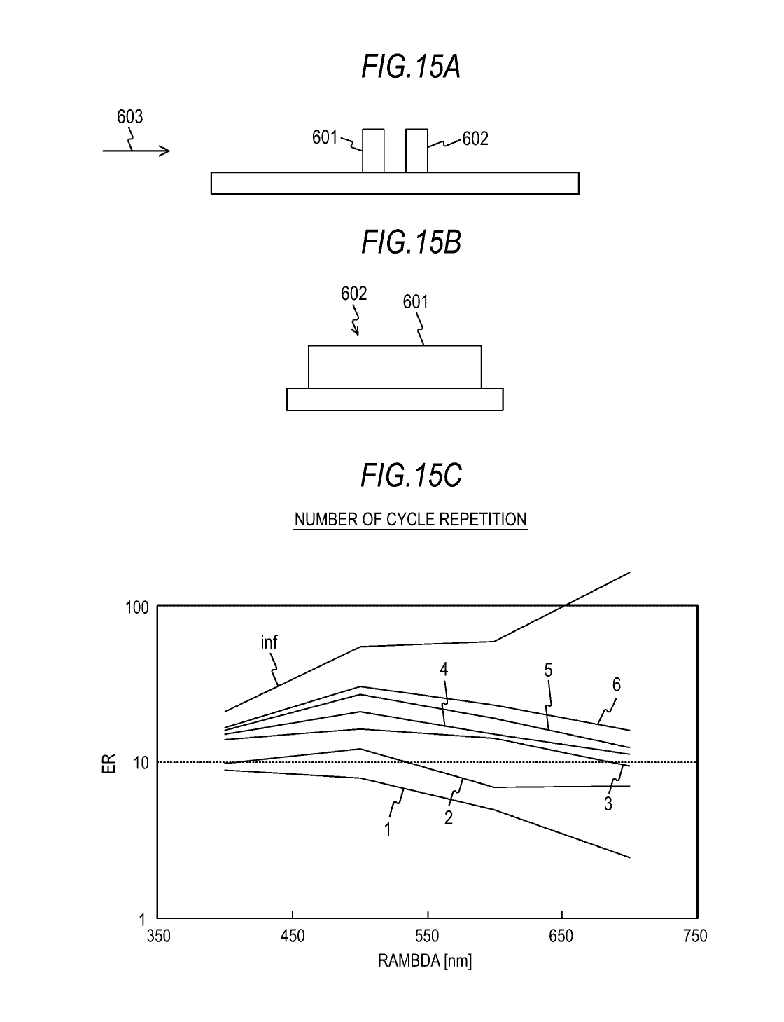

Based on the fact that a crosstalk limit is 10%, how the interval, the duty (=wire width divided by interval), the height, and the number of cycle repetitions, which are necessary for the wire-grid polarizer to achieve an extinction ratio greater than or equal to 10, change the extinction ratio is calculated. FIGS. 14A to 14C and 15A to 15C show examples of results of the calculation.

FIGS. 14A to 14C and 15A to 15C show examples of results of the calculation obtained by changing the interval, the height, the duty (=wire width divided by interval), and the length of the wire-grid polarizer in the first embodiment of the present disclosure. The left side of FIGS. 14A to 14C shows graphs representing the relationship between the extinction ratio (vertical axis) and the wavelength (horizontal axis), and the right side of FIGS. 14A to 14C shows graphs representing the relationship between the transmittance (vertical axis) and the wavelength (horizontal axis).

FIG. 14A shows results obtained by changing the interval. Specifically, FIG. 14A shows an example of calculation results obtained by changing the interval P between the wires 310 from 150 to 300 nm. The curves in FIG. 14A are labeled with values representing the interval P between the wires 310 (150, 175, 200, 250, and 300).

As shown in FIG. 14A, it is necessary to set the interval P between the wires 310 at 200 nm or smaller in order to achieve an extinction ratio greater than 10.

FIG. 14B shows results obtained by changing the height. Specifically, FIG. 14B shows an example of calculation results obtained by changing the height H of the wires 310 from 100 to 250 nm. The curves in FIG. 14B are labeled with values representing the height H of the wires 310 (100, 150, 200, and 250).

As shown in FIG. 14B, the extinction ratio increases as the height H of the wires 310 increases, whereas the transmittance decreases as the height H of the wires 310 increases. That is, there is a tradeoff between the height H of the wires 310 and the transmittance. It is necessary to set the height H of the wires 310 at 50 nm or greater in order to achieve an extinction ratio greater than 10.

FIG. 14C shows results obtained by changing the duty. Specifically, FIG. 14C shows an example of calculation results obtained by changing the duty (=wire width divided by interval) of the wires 310 from 0.33 to 0.5. The curves in FIG. 14C are labeled with values representing the duty (=wire width divided by interval) of the wires 310 (0.33 and 0.5).

As shown in FIG. 14C, the extinction ratio increases as the duty (=wire width divided by interval) of the wires 310 increases, whereas the transmittance decreases as the duty of the wires 310 increases. That is, there is a tradeoff between the duty (=wire width divided by interval) of the wires 310 and the transmittance. It is necessary to set the duty (=wire width divided by interval) at 0.33 or greater in order to achieve an extinction ratio greater than 10.

FIGS. 15A and 15B schematically show an aluminum wire model (grid shape model) having a structure including two pillars independent of each other. That is, FIG. 15A is a front view of the aluminum wire model (grid shape model) having pillars 601 and 602. FIG. 15B is a side view of the aluminum wire model (grid shape model) having the pillars 601 and 602 (viewed in the direction indicated by an arrow 603 in FIG. 15A).

FIG. 15C shows results of calculation of the extinction ratio for the aluminum wire model (grid shape model) shown in FIGS. 15A and 15B having a wire length ranging from 1 to 6 μm to infinity. Specifically, FIG. 15C shows graphs representing the relationship between the extinction ratio (vertical axis) and the wavelength (horizontal axis) (wire grid length=6, 5, 4, 3, 2, 1, ∞ (inf) [μm]). The curves in FIG. 15C are labeled with values representing the wire length (6, 5, 4, 3, 2, 1, and inf).

As seen from FIG. 15C, it is believed that the extinction ratio more greatly depends on the wire length than the number of wires, and that the wire length determines the limit to which a wire model can be used. When the wire length decreases, the extinction ratio on the RED side degrades or decreases to 10 or smaller at a length of 2 μm.

It is therefore believed that a necessary wire length is 2 μm or longer, and that a necessary total length in the direction in which the wires are arranged is similarly sized. Based on the assumption described above, it is believed that an appropriate cycle in the wire structure is 10 or greater when the wires are arranged at an interval of 200 nm.

From the results described above, the wire-grid polarizer preferably has the following structure when the wires are made of aluminum: The grid is so configured that the interval is 200 nm or smaller, the duty (=wire width divided by interval) is ⅓ or greater, the height is 50 nm or greater, and the cycle is 10 or greater.

### [Example of Positional Relationship Between Wire-Grid Polarizer and Pixels]

As shown in FIG. 6A, the polarization image sensor formed of the wire-grid polarizers and the imaging device includes the photoelectric conversion devices, the color filter, the on-chip lenses (OCLs), and the wire-grid polarizers.

If light leaks from a pixel to an adjacent pixel due to scattering, diffraction, and other phenomena caused by the polarizers on the OCLs, the light leakage causes color contamination, ghost images, and noise. To address the problems, the light fluxes having been separated in the position of the diaphragm in accordance with the polarization direction, which form right and left images, are typically required to be precisely separated by the polarizers on the OCLs and incident on the pixels.

In general, a polarizer as an optical component, which produces a phase difference between an ordinary ray and an extraordinary ray, needs a certain thickness. Commercially available polarizers formed of a resin film have a thickness of several hundreds of micrometers, and those made of calcite, mica, quartz, or any other crystalline material have a thickness ranging from several hundreds to several micrometers. It has also been reported that a polarizer having a cyclic structure made, for example, of a photonic crystal has a thickness of 5 μm.

In view of the fact described above, for example, when polarizers are formed on OCLs in a current COMS image sensor having a pixel size of 2.5 μm or smaller, the polarizers, which detect polarization directions, are positioned above the pixel plane by at least 5 μm. It is therefore difficult to separate polarized light precisely without color contamination into the pixels on the silicon chip surface, which are arranged at an interval of 2.5 μm.

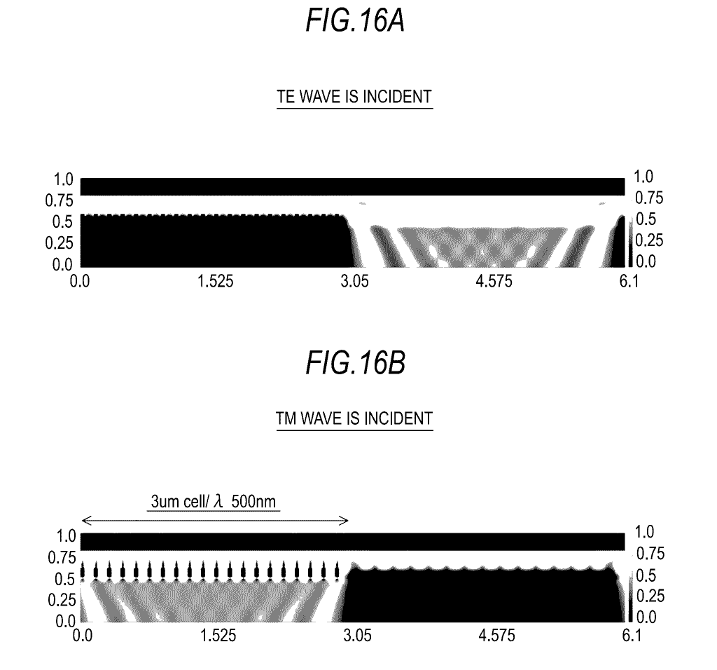

To address the problem described above, the wire-grid polarizers are used in the first embodiment of the present disclosure. For example, the wire-grid polarizers, the thickness of which can be several hundreds of nanometers, can be placed immediately above the OCLs. FIGS. 16A and 16B shows a case where a grid formed of wires perpendicular to each other is formed in each divided area having a size of 3 μm and polarization separation after a TE wave or a TM wave is incident on the grids is calculated.

FIGS. 16A and 16B show a simulation of light propagation through the wire-grid polarizer in the first embodiment of the present disclosure. In the example shown in FIGS. 16A and 16B, the horizontal and vertical axes are marked in μm.

As shown in FIGS. 16A and 16B, in a propagation area having a thickness of at least 0.75 μm, light fluxes separated in accordance with the polarization direction reach a pixel area adjacent to the propagation area without color contamination, diffraction, or scattering.

As described above, since the polarizers are formed immediately above the OCLs in the first embodiment of the present disclosure, the amount of light leakage into an adjacent pixel (color contamination) is small, whereby a clear image can be produced. Further, each wire-grid polarizer can be designed to achieve an arbitrary extinction ratio by appropriately setting the interval, the height, the duty, and other parameters. Moreover, the wire-grid polarizers, which can be formed in typical semiconductor processes, can be formed in compatibility with image sensor processes. Further, each polarizer can have an arbitrary polarization direction and can be formed on an arbitrary pixel.

Further, a small, single-panel (that is, single sensor) image sensor can be used to capture stereoscopic images (what is called 3D imaging). Moreover, an arbitrary polarized image can be produced for each pixel.

Further, according to the first embodiment of the present disclosure, since the imaging apparatus 100 is formed of a set of pupil polarizing unit 120 and imaging device polarizing unit 130 and one lens system 110, for example, right and left two different separated images can be simultaneously produced. A small, single-lens imaging apparatus having a simple structure with a small number of parts can thus be provided. That is, a small imaging apparatus capable of producing stereoscopic images at low cost can be provided.

Since two sets of lens and polarizing filter are not necessary, no shift or difference in zooming, limiting light, focusing, convergence angle, and other parameters will occur. Further, since the base line length of binocular parallax is relatively small, a natural stereoscopic sensation can be provided. Moreover, when the pupil polarizing unit 120 can be removably inserted at the position of the diaphragm 113, a planar image (two-dimensional image) and stereoscopic images (3D image) can be readily produced.

As compared with a time division method (that is, a method for alternately capturing right and left images in time sequence by switching right and left shutters at the position of the diaphragm), right and left images can be captured simultaneously and the number of mechanical parts can be reduced. Further, the image sensor can be functionally integrated. Moreover, any loss associated with shuttering or any decrease in efficiency of imaging resulting from an increase in temporal frequency will not occur, whereby a bright image can be produced.

### 2. Second Embodiment

The first embodiment of the present disclosure has been described with reference to the case where an imaging apparatus including one lens system produces stereoscopic images (what is called a single-lens reflex 3D camera). The first embodiment of the present disclosure is also applicable to an imaging apparatus including a plurality of lens systems and capable of producing stereoscopic images by using the lens systems (twin-lens 3D camera, for example). A second embodiment of the present disclosure will be described with reference to an imaging apparatus including a plurality of lens systems.

### [Example of Configuration of Imaging Apparatus]

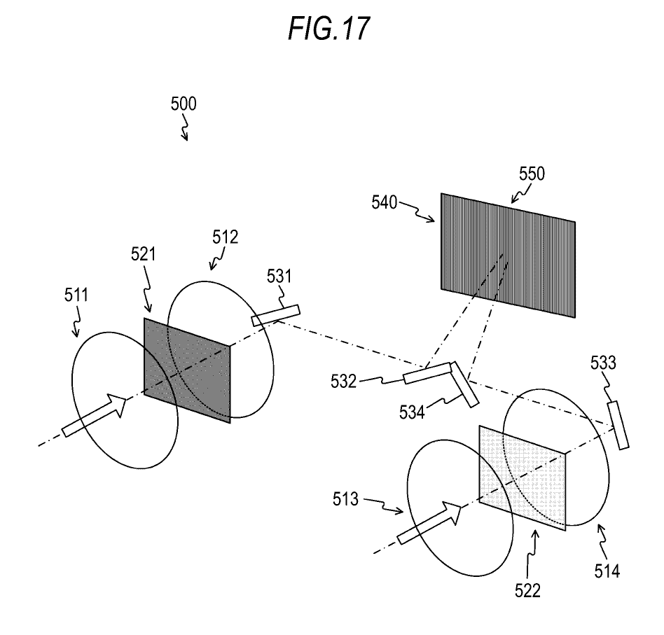

FIG. 17 is a perspective view showing an example of the internal configuration of an imaging apparatus 500 according to the second embodiment of the present disclosure.

The imaging apparatus 500 includes first lens groups 511 and 513, second lens groups 512 and 514, a first polarizer 521, a second polarizer 522, mirrors 531 to 534, an imaging device polarizing unit 540, and an imaging device 550. The first polarizer 521 is disposed in the vicinity of a diaphragm (not shown) in a first optical system (first lens group 511 and second lens group 512) that collects light from a subject. The second polarizer 522 is disposed in the vicinity of a diaphragm (not shown) in a second optical system (first lens group 513 and second lens group 514). The imaging apparatus 500 thus includes two lens systems (first lens groups 511, 513 and second lens groups 512, 514) and one imaging device 550.

The first polarizer 521 corresponds to the first polarizer 121 shown in FIGS. 1A and 1B and other figures, and the second polarizer 522 corresponds to the second polarizer 122 shown in FIGS. 1A and 1B and other figures. The imaging device polarizing unit 540 corresponds to the imaging device polarizing unit 130 shown in FIGS. 1A and 1B and other figures. The image processor and other components are substantially the same as the image processor 170 and other components shown in FIGS. 1A and 1B and other figures and will not therefore be illustrated or described.

The embodiments of the present disclosure are also applicable to other apparatus having an imaging capability that allows a variety of images (such as stereoscopic images) to be handled (such as mobile phones, navigations systems, and mobile media players).

The embodiments of the present disclosure are presented by way of example for embodying the present disclosure. As explicitly stated in the embodiments of the present disclosure, items in the embodiments of the present disclosure are related to specific inventive items set forth in the appended claims. Similarly, the specific inventive items in the appended claims are related to the items having the same names in the embodiments of the present disclosure. It is, however, noted that the present disclosure is not limited to the embodiments but can be embodied with a variety of changes made to the embodiments to the extent that the changes do not depart from the substance of the present disclosure.

Each of the procedures described in the embodiments of the present disclosure may be taken as a method including a series of processes of the procedure or may be taken as a program that instructs a computer to carry out the series of processes or a recording medium on which the program is recorded. Examples of the recording medium may include a CD (compact disc), an MD (minidisc), a DVD (digital versatile disk), a memory card, and a Blu-ray disc®.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
two polarizers that are disposed in the vicinity of a diaphragm and polarize light from a subject, the two polarizers being a first polarizer and a second polarizer whose polarization directions are perpendicular to each other;
two polarizers that polarize the light from the subject and are alternately disposed in a photodetection plane of an imaging device along an orthogonal direction perpendicular to a parallax direction, along which the first polarizer and the second polarizer are connected to each other, in such a way that the two polarizers extend in the orthogonal direction, the two polarizers being a third polarizer whose polarization direction is parallel to the polarization direction of the first polarizer and a fourth polarizer whose polarization direction is parallel to the polarization direction of the second polarizer; and
an image processor that processes image data produced by the imaging device in such a way that image data produced based on light having passed through the first polarizer and the third polarizer are handled as first image data for displaying stereoscopic images and image data produced based on light having passed through the second polarizer and the fourth polarizer are handled as second image data for displaying the stereoscopic images,
wherein the imaging device has pixels arranged in a matrix identified by the parallax direction and the orthogonal direction, and
wherein the third polarizer and the fourth polarizer are alternately disposed on a predetermined arrangement unit basis, the predetermined arrangement unit being a line or lines extending in the orthogonal direction and the line corresponding to two pixels in the parallax direction in the imaging device.

2. The imaging apparatus according to claim 1, wherein the image processor produces the first image data and the second image data by rearranging the image data produced by the imaging device on a predetermined unit basis, the predetermined unit being a line extending in the orthogonal direction and corresponding to each of the third polarizers and each of the fourth polarizers.

3. The imaging apparatus according to claim 1, wherein the image processor produces the first image data and the second image data by summing the image data produced by the imaging device on a predetermined unit basis, the predetermined unit being a line extending in the orthogonal direction and corresponding to each of the third polarizers and each of the fourth polarizers, and then rearranging the summed image data.

4. The imaging apparatus according to claim 1, wherein the image processor processes the image data produced by the imaging device in such a way that image data sequentially read on a predetermined unit basis, the predetermined unit being a line extending in the orthogonal direction and corresponding to each of the third polarizers, are handled as the first image data, and that image data sequentially read on a predetermined unit basis, the predetermined unit being a line extending in the orthogonal direction and corresponding to each of the fourth polarizers, are handled as the second image data.

5. The imaging apparatus according to claim 1, wherein the image processor processes the image data produced by the imaging device in such a way that image data on a predetermined unit basis, the predetermined unit being a line extending in the orthogonal direction and corresponding to each of the third polarizers, are summed and the summed image data are then sequentially read and handled as the first image data, and that image data on a predetermined unit basis, the predetermined unit being a line extending in the orthogonal direction and corresponding to each of the fourth polarizers, are summed and the summed image data are then sequentially read and handled as the second image data.

6. The imaging apparatus according to claim 1, wherein the pixels in the imaging device are disposed in a primary color Bayer arrangement.

7. The imaging apparatus according to claim 1, wherein the first polarizer and the second polarizer are disposed adjacent to each other on opposite sides of the orthogonal direction as a boundary in the vicinity of the diaphragm in a single optical system that collects the light from the subject.

8. The imaging apparatus according to claim 1, wherein the first polarizer is disposed in the vicinity of the diaphragm in a first optical system that collects the light from the subject, and the second polarizer is disposed in the vicinity of the diaphragm in a second optical system that collects the light from the subject.

9. The imaging apparatus according to claim 1, wherein the image processor produces the first image data and the second image data as image data to be recorded on a recording medium based on a predetermined recording format.

10. The imaging apparatus according to claim 1, wherein the image processor produces the first image data and the second image data as image data to be recorded on a recording medium based on a recording format using a side by side scheme.

11. The imaging apparatus according to claim 1, wherein the parallax direction is a direction of parallax associated with the stereoscopic images.

12. An image processing method comprising:
acquiring image data produced by an imaging device based on light incident thereon via two polarizers that are disposed in the vicinity of a diaphragm and polarize light from a subject, the two polarizers being a first polarizer and a second polarizer whose polarization directions are perpendicular to each other, a parallax direction being a direction along which the first polarizer and the second polarizer are connected to each other, and two polarizers that polarize the light from the subject and are alternately disposed in a photodetection plane of the imaging device along an orthogonal direction perpendicular to the parallax direction in such away that the two polarizers extend in the orthogonal direction, the two polarizers being a third polarizer whose polarization direction is parallel to the polarization direction of the first polarizer and a fourth polarizer whose polarization direction is parallel to the polarization direction of the second polarizer; and
performing image processing in which image data produced based on light having passed through the first polarizer and the third polarizer are handled as first image data for displaying stereoscopic images and image data produced based on light having passed through the second polarizer and the fourth polarizer are handled as second image data for displaying the stereoscopic images,
wherein the imaging device has pixels arranged in a matrix identified by the parallax direction and the orthogonal direction, and
wherein the third polarizer and the fourth polarizer are alternately disposed on a predetermined arrangement unit basis, the predetermined arrangement unit being a line or lines extending in the orthogonal direction and the line corresponding to two pixels in the parallax direction in the imaging device.

13. A program that instructs a computer to perform:
acquiring image data produced by an imaging device based on light incident thereon via two polarizers that are disposed in the vicinity of a diaphragm and polarize light from a subject, the two polarizers being a first polarizer and a second polarizer whose polarization directions are perpendicular to each other, a parallax direction being a direction along which the first polarizer and the second polarizer are connected to each other, and two polarizers that polarize the light from the subject and are alternately disposed in a photodetection plane of the imaging device along an orthogonal direction perpendicular to the parallax direction in such away that the two polarizers extend in the orthogonal direction, the two polarizers being a third polarizer whose polarization direction is parallel to the polarization direction of the first polarizer and a fourth polarizer whose polarization direction is parallel to the polarization direction of the second polarizer; and
performing image processing in which image data produced based on light having passed through the first polarizer and the third polarizer are handled as first image data for displaying stereoscopic images and image data produced based on light having passed through the second polarizer and the fourth polarizer are handled as second image data for displaying the stereoscopic images,
wherein the imaging device has pixels arranged in a matrix identified by the parallax direction and the orthogonal direction, and
wherein the third polarizer and the fourth polarizer are alternately disposed on a predetermined arrangement unit basis, the predetermined arrangement unit being a line or lines extending in the orthogonal direction and the line corresponding to two pixels in the parallax direction in the imaging device.
